(19) United States
(12) Patent Application Publication
(10) Pub. No.: US 2026/0336628 A1
(43) Pub. Date: Oct. 29, 2026

(54) COORDINATION OF VEHICLE OPERATION

(71) Applicant: University of Southern California, Los Angeles, CA (US)

(72) Inventors: Muhammad Waqas, Los Angeles, CA (US); Petros Ioannou, Palos Verdes Estates, CA (US)

(21) Appl. No.: 19/106,909

(22) PCT Filed: Jun. 29, 2023
(86) PCT No.: PCT/US2023/026641

§ 371 Date: Feb. 26, 2025

Related U.S. Application Data
(60) Provisional application No. 63/402,324, filed on Aug. 30, 2022.

(51) Int. Cl. B60W 30/182; B60W 30/09; B60W 30/095; B60W 30/14; B60W 30/165

(52) U.S. Cl. CPC B60W 30/182; B60W 30/09; B60W 30/0956; B60W 30/143; B60W 30/165; B60W 2552/30; B60W 2554/20; B60W 2554/40

(57) ABSTRACT

Aspects of this technical solution can include detecting, by a sensor of a vehicle, an object in an environment of the vehicle, determining, in response to the detecting, that the object corresponds to an in-path object intersecting a path of the vehicle, identifying, in response to the detecting, that the object corresponds to a potentially invisible vehicle in the path of the vehicle, a lead vehicle, or a stationary object, and modifying a mode of operation of the vehicle in response to the identifying. The environment of the vehicle can include one or more of road curvature, slope, superelevation, lane width and noise in the sensors due to weather conditions, and road friction.

### STATEMENT REGARDING FEDERALLY SPONSORED RESEARCH OR DEVELOPMENT

This invention was made with government support under Grant Number 202-366-4000, awarded by the United States Department of Transportation (USDOT). The government has certain rights in the invention.

### TECHNICAL FIELD

The present implementations relate generally to controls systems, including, but not limited to, coordination of vehicle operation.

### INTRODUCTION

Drivers increasingly demand more sophisticated control and delegation options in connection with a driving experience. However, conventional systems cannot effectively identify objects around the curve that are outside the view of the vehicle.

### SUMMARY

This technical solution can include a grid-based evidential model to extract semantic information by exploiting georeferenced maps that contains lane-level information. For example, a predetermined map can be assumed to be accurate. For example, the only significant error can be the error in localization of ego vehicle with respect to a global frame. For example, the position of all grid cells surrounding the ego vehicle can be accurately known with respect to ego vehicle's frame. However, position of all grid cells may not be guaranteed under all conditions. The detection error and localization error could compound each other. This technical solution provides a technical improvement at least by considering not only localization error but also taking into account uncertainty in detection and tracking of objects by on-board sensors. Thus, a technological solution for coordination of vehicle operation is provided.

At least one aspect is directed to a method for coordination of vehicle operation. The method can include detecting, by a sensor of a vehicle, an object in an environment of the vehicle. The method can include determining, in response to the detecting, that the object corresponds to an in-path object intersecting a path of the vehicle. The method can include identifying, in response to the detecting, that the object corresponds to a potentially invisible vehicle in the path of the vehicle, a lead vehicle, or a stationary object. The method can include modifying a mode of operation of the vehicle in response to the identifying.

At least one aspect is directed to a system for coordination of vehicle operation. The system can include a memory and one or more processors. The system can detect, by a sensor of a vehicle, an object in an environment of the vehicle. The system can determine, in response to the detection, that the object corresponds to an in-path object intersecting a path of the vehicle. The system can identify, in response to the detection, that the object corresponds to a potentially invisible vehicle in the path of the vehicle, a lead vehicle, or a stationary object. The system can modify a mode of operation of the vehicle in response to the identifying.

At least one aspect is directed to a vehicle for coordination of vehicle operation. The system can include a sensor, a memory and one or more processors. The system can detect, by the sensor, an object in an environment of the vehicle. The system can determine, in response to the detection, that the object corresponds to an in-path object intersecting a path of the vehicle. The system can identify, in response to the detection, that the object corresponds to a potentially invisible vehicle in the path of the vehicle, a lead vehicle, or a stationary object. The system can cause the vehicle to modify a mode of operation of the vehicle in response to the identifying.

At least one aspect is directed to a non-transitory computer readable medium that can include one or more instructions stored thereon and executable by a processor. The processor can detect, via a sensor of a vehicle, an object in an environment of the vehicle. The processor can determine, in response to the detection, that the object corresponds to an in-path object intersecting a path of the vehicle. The processor can identify, in response to the detection, that the object corresponds to a potentially invisible vehicle in the path of the vehicle, a lead vehicle, or a stationary object. The processor can modify a mode of operation of the vehicle in response to the identifying.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates a system in accordance with present implementations.

FIG. 2 illustrates a method of automatic vehicle following under predetermined preference parameters and road geometry conditions in accordance with present implementations.

FIG. 3 illustrates a detection by a system in accordance with present implementations.

FIG. 4 illustrates a detection by a system in accordance with present implementations.

FIG. 5A illustrates a detection in a first example environment in accordance with present implementations.

FIG. 5B illustrates a detection in a second example environment in accordance with present implementations.

FIG. 6 illustrates a detection in a third example environment in accordance with present implementations.

FIG. 7 illustrates a detection in a fourth example environment in accordance with present implementations.

FIG. 8 illustrates a method of automatic vehicle following under predetermined preference parameters and road geometry conditions in accordance with present implementations.

FIG. 9 illustrates a model corresponding to road geometry in accordance with present implementations.

FIG. 10A illustrates a first model corresponding to various vehicle modes, in accordance with present implementations.

FIG. 10B illustrates a second model corresponding to various vehicle modes, in accordance with present implementations.

FIG. 10C illustrates a model corresponding to throttle activation, in accordance with present implementations.

FIG. 10D illustrates a model corresponding to brake activation, in accordance with present implementations.

FIG. 11 illustrates a first operating profile of a vehicle, in accordance with present implementations.

FIG. 12 illustrates a second operating profile of a vehicle, in accordance with present implementations.

FIG. 13 illustrates a third operating profile of a vehicle, in accordance with present implementations.

FIG. 14 illustrates a processor architecture in accordance with present implementations.

FIG. 15 illustrates a method of coordination of vehicle operation, in accordance with present implementations.

FIG. 16 illustrates a method of coordination of vehicle operation, in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software can not be limited thereto, but can include implementations implemented in hardware, or combinations of software and hardware, and vice-versa, as will be apparent to those skilled in the art, unless otherwise specified herein. In the present specification, an implementation showing a singular component can not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

The Advanced Driver Assistance Systems (ADAS) can assist drivers and enhance performance and driving comfort. For example, ADAS can include adaptive cruise control (ACC) which provides automatic vehicle following capabilities in the longitudinal direction. A goal of ACC can be to match the speed of a leading vehicle while keeping optimal distance and within certain acceleration constraints for driver comfort. The inter-vehicle spacing can be often measured in units of time and can be referred to as time headway. For example, time headway can be defined as the time it takes for the vehicle to cover the distance between the two vehicles. Time headway policies can be designed for the case of an ego vehicle following a lead vehicle on a straight road. For example, an ego vehicle can correspond to a vehicle performing one or more operations in accordance with present implementations. The ego vehicle travelling on a curved path or transitioning from straight road to a sharp curve, needs special attention. All automatic vehicle following, and cruising systems rely on on-board sensors for the effective detection and tracking of objects in their environment. Thus, there can be a long felt need for collision avoidance with potential in-path objects not visible by on-board sensors under all possible road geometry characteristics and traffic conditions. For sharp turns, various methods can be proposed to avoid false alarms from objects from the adjacent lanes. For sharp turns, there can be a need for avoiding collision with potentially invisible objects on sharp curves.

In vehicle following and cruising systems, the desired velocity of the ego vehicle can be a function of relative spacing and relative velocity of the lead vehicle and the ego vehicle. The sensor error may optionally be considered in determining the desired velocity of the ego vehicle. In favorable weather and lighting conditions, the sensor error can be low. However, in adverse weather and lighting conditions, the sensor error can be significant. The fatal accident of a pedestrian by an autonomous vehicle underscores the need to include the sensor error in determining the target speed of the ego vehicle. Preemptive actions need to be incorporated in autonomous vehicles to enhance performance and prevent collisions a human driver could have easily avoided.

The design of feasible and optimal vehicle following and cruising systems depends on the effective detection of objects in ego vehicle's path under all conditions. The forward-looking sensors may detect obstacles not in the path of the vehicle or fail to detect obstacles around curves which can be in the path of the vehicle sensor fusion of multiple sensors like LiDAR, radar, vision, GPS and inertial measuring units (IMUs). However, each sensor has its own limitations. LiDAR and cameras have wider field of view than that of radar, whereas radar can be more robust to weather conditions. These sensors complement each other in ideal weather and road conditions. During adverse weather or on a curved road these sensor fusion techniques may not be enough to meet performance constraints of having enough time and space to avoid a collision. Adverse weather affects LiDAR and camera performance while curved paths limit the visibility of radar for the road ahead. Under adverse weather conditions and sharp turns, certain objects, like a parked car on the edge of road on a sharp curve, might not be visible by the forward looking exteroceptive sensors.

In-path object detection can be done through vehicle localization, obstacle detection and tracking in vehicle following and cruising systems. Localization means ascertaining the spatial relationship of a vehicle in its environment with respect to relatively static objects. In general, simultaneous localization and mapping (SLAM) and detection and tracking of moving objects (DATMO) can be two important major tasks. Various methods depending on the geometry of the road can detect whether an object can be on the vehicle's path.

Simultaneous Localization, Mapping and Moving Object Tracking (SALMMOT) can include integrating the SLAM and DATMO approaches. Sensor fusion of radar, LiDAR, camera, GPS receiver, inertial measurement unit (IMU) has been used for SLAM and DATMO in dynamical environment. Thus, this technical solution can include a map-based localization using LiDAR, GPS and IMU. Visual sensor-based lane detection system can be proposed. These techniques can be reliable in favorable weather and road conditions and may be subject to interference in adverse conditions. For example, path planning can incorporate high resolution and accurate maps. Information from pre-generated (or offline) map can be used for localization of the vehicle. Global Information System (GIS) can be used for road detection by using high-level and low-level cues. Even though map accuracy has been improved due to sophisticated data acquisition devices, the sensor error can be a major source of uncertainties. The sensor error results in uncertainty in localization, detection and tracking of objects in the ego vehicle's surroundings. The localization techniques can be divided into three broad categories: localization using onboard sensors, localization using vehicle to vehicle (V2V) communication and localization using vehicle to infrastructure communication.

Under certain conditions, it can be possible that on-board sensors fail to detect objects in the path of ego vehicle. In order to ensure performance there can be a need to design an optimal vehicle following system which takes into account such scenarios. Drivers intuitively reduce the speed in preemptive manner to avoid collision with possible obstacles when visibility can be reduced due to weather conditions or road geometry. For example, when driving around sharp curves, the on-board sensors may not be able to sense an obstacle such as a parked vehicle early enough for the vehicle to have time to avoid the collision. Another important task when driving around curves can be to limit the lateral acceleration for stability and driving comfort. Lateral acceleration can be limited to 0.2 g m/s² to ensure human comfort at all times. Ninetieth percentile values of lateral acceleration can be below 0.2 g m/s² for six lane and four lane highways. A human-in-loop system based on fuzzy logic control (FLC) does not consider the decrease in visibility of ego vehicle's path as detected by the on-board sensors due to curvature of the road.

This technical solution includes an automatic vehicle following and cruising system that can effectively operate in the presence of adverse weather conditions and sensor uncertainties in localization and detection. It analyses the impact of noise in sensor data and uses a probabilistic approach to determine the desired velocity. The current systems may switch off the ACC mode and transfer the control of the vehicle to human driver under sensor uncertainties, adverse weather and road conditions. As a result, current ACC systems may become annoying when such adverse conditions come up frequently, thereby discouraging the use of ACC. Thus, this technical solution can include a technical improvement of an improved ACC system that takes into account adverse conditions in maintaining performance and expands its operating regime by limiting the frequency of switch offs of the automated mode to manual mode.

This technical solution includes avoiding collision with potential obstacles that the sensors may fail to detect due to the curvature of the road. Criteria can be developed for optimal velocity that depends upon field of view of sensors, maximum braking capability of the ego vehicle, road friction, and road geometry including curvature, slope and superelevation. On sharp turns the system preemptively decelerates the ego vehicle to limit lateral acceleration and to ensure collision avoidance with obstacles that can be invisible to on-board sensors due to the curvature of the road. Thus, this technical solution can provide efficient and rapid modification to vehicle navigation in view of an accurate model of objects in an environment, beyond the capability of manual processes to achieve. For example, a manual process of visual inspection cannot detect objects obscured or hidden from visual inspection.

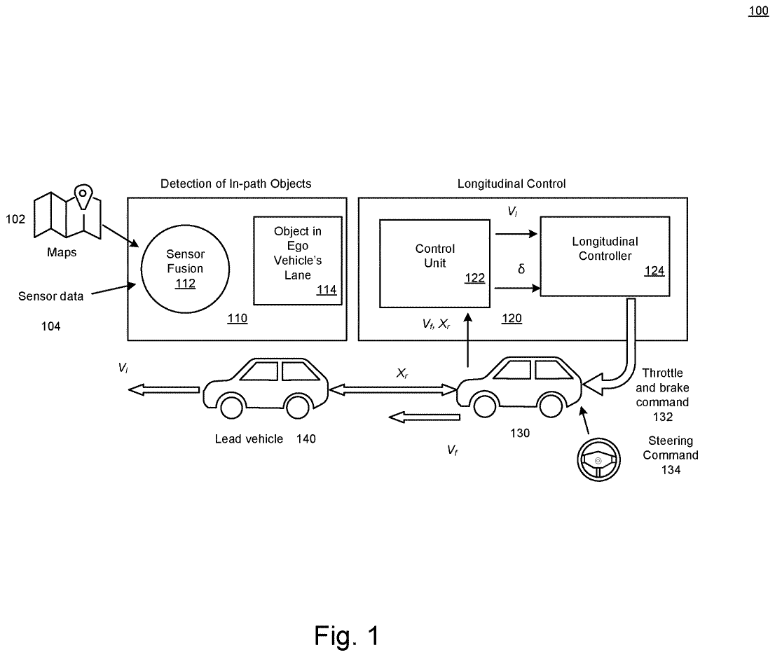

FIG. 1 illustrates system in accordance with present implementations. As illustrated by way of example in FIG. 1, an example system 100 can obtain a map input 102, sensor data 104 a throttle and brake command 132, and a steering command 134, and can include a detection system 110, a sensor fusion processor 112, an object detector 114, a control system 120, a control unit 122, a longitudinal controller 124, an ego vehicle 130, and a lead vehicle 140. The system 100 can be directed to an automatic vehicle following under performance and comfort constraints.

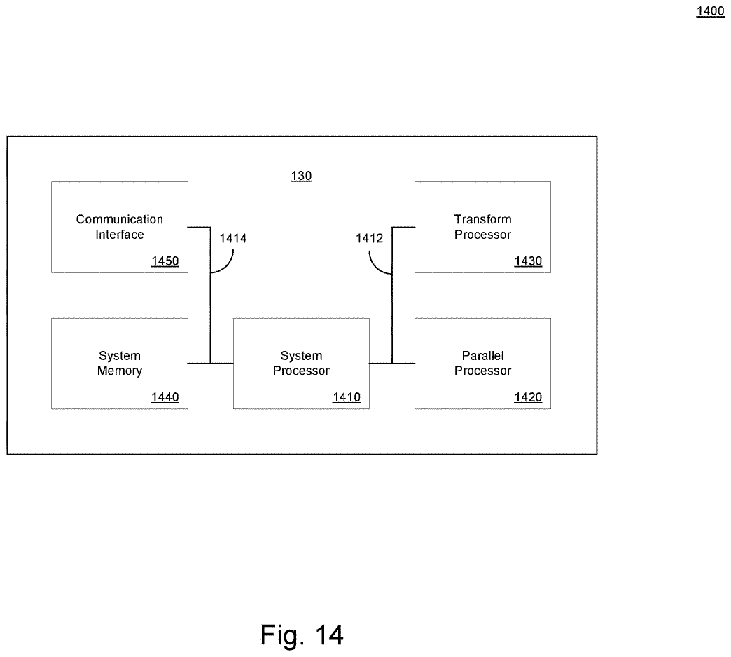

The high-level description of optimal vehicle following and cruising system can be shown in FIG. 1. It has the following major modules: in-path object detection and tracking, the control unit and longitudinal controller. A lane keeping controller can be in place either by a human in the case of partial automation or the autonomous vehicle in case of automated driving. The in-path object detection and tracking module scans the space in front of the ego vehicle's lane. This module uses LiDAR, camera, radar, GPS, IMU and geo-referenced maps containing lane-level information. This module detects and tracks the nearest object in the path of ego vehicle and calculates the probability Pᵢₙ₋ₚₐₜₕ that the detected object lies in ego vehicle's path, the relative distance Xᵣ and the velocity of the object Vₗ in the ego vehicle's coordinates. For example, the IMU can be implemented by the processor architecture of FIG. 14 or any component thereof. For example, the in-path object detection and tracking module can generate various outputs. For example, the in-path object detection and tracking module can detect a lead vehicle (Vₗ, Xᵣ) in the ego vehicle's lane with probability Pᵢₙ₋ₚₐₜₕ. For example, the in-path object detection and tracking module can detect a stationary object in the ego vehicle's lane. (Vₗ=0, Xᵣ), with probability Pᵢₙ₋ₚₐₜₕ. For example, the in-path object detection and tracking module can detect a potentially invisible object in ego vehicle's path. This includes possible slow moving or stationary vehicles around curves not visible by on board sensors and cannot be detected early enough for collision avoidance to be effective.

For example, these detections can correspond to various road geometry scenarios. For example, a road geometry scenario can correspond to an ego vehicle moving on straight lane cruising or following a lead vehicle in the same lane. For example, a road geometry scenario can correspond to an ego vehicle moving on curved path cruising or following a lead vehicle in the same lane.

The automatic vehicle following and cruising system can handle the above two scenarios under different weather conditions affecting visibility of sensors as well as possible invisible obstacles due to road geometry. The in-path object detection and tracking module has three outputs: speed of the detected object Vₗ, distance between lead and following vehicle Xᵣ, probability Pᵢₙ₋ₚₐₜₕ that the detected object lies in the ego vehicle's path. The second module can be the longitudinal control. It takes Vₗ, Xᵣ, Pᵢₙ₋ₚₐₜₕ, road geometry and calculates throttle and brake commands. The throttle and brake commands can be generated such that the velocity of the ego vehicle tracks the desired velocity V_{des} and desired spacing requirements. The desired velocity can be selected based on the situation in a way that the vehicle has enough time to stop in case of possible emergencies. These possible emergencies may include scenarios where the sensors can be having a hard time to detect possible in-path objects in which case the desired velocity can be reduced giving time for the sensors to provide improved measurements. This could happen under bad weather conditions, dark nights or around sharp curves.

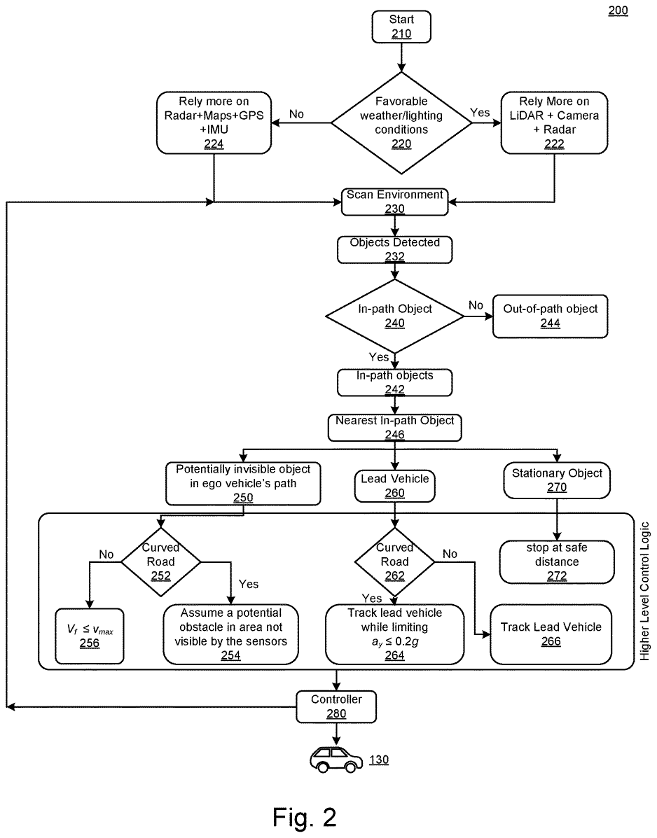

FIG. 2 illustrates a method of automatic vehicle following under predetermined preference parameters and road geometry conditions in accordance with present implementations. At least the system 100 can perform method 200 according to present implementations. The method 200 can include steps 210, 220, 222, 224, 230, 232, 240, 242, 244, 246, 250, 252, 254, 256, 260, 262, 264, 266, 270, 272 and 280. The method 200 can be directed to automatic vehicle following under performance and comfort constraints.

The In-Path Object Detection and Tracking module scans the environment to detect and track the nearest in-path objects. It calculates the distance of the object from the vehicle, the probability that the object lies in the ego vehicle's path and the velocity of the object. When the weather and/or lighting conditions can be favorable then the traditional LiDAR and vision sensor fusion techniques can reliably detect and track objects in the ego vehicle's path. However, in rain, fog, darkness or other adverse weather conditions LiDAR and camera can be unreliable. As radar can be robust to weather conditions, researchers can be investigating complementary approaches using radar. Radar data can be incorporated with maps to make in-path detection. In radar target tracking, the measurement of range can be relatively more accurate as compared to azimuth angle measurement. Therefore, even a small error in the angle produces large error in lateral position of the target. In this case, the lateral position of the target, e.g., the lane in which the object can be situated, can be very important so the effect of sensor errors must be taken into account. This application's contribution can be to provide a complete statistical analysis of error in determination of lane-level information of the detected object in the presence of localization error and detection error. The uncertainty in determining the lane-level information can be quantified and this quantification can be used to calculate a probabilistic measure of the desired velocity of the ego vehicle. This solution can present a maximum likelihood (ML) decision rule to determine the lane of the detected object. After ML estimation, if it can be estimated that the detected object lies in the path lane of the ego vehicle, then the desired velocity of the ego vehicle can be determined by considering the velocity of the detected object and the probability that the detected object lies in ego vehicle's path lane.

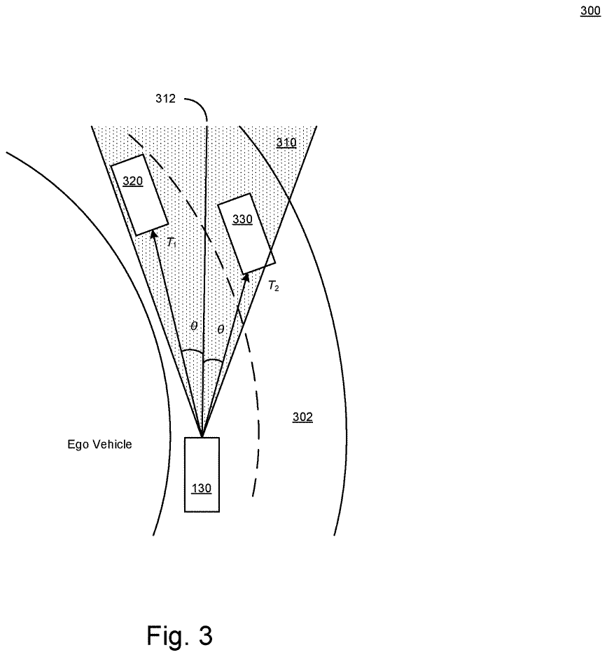

FIG. 3 illustrates a detection by a system in accordance with present implementations. As illustrated by way of example in FIG. 3, an example environment 300 can include the ego vehicle 130, a curved path 302, a sensor detection area 310, a sensor center line 312, an in-path object 320, an out-of-path object 330. For example, FIG. 3 can be directed to a vehicle on a curved path.

If n objects can be detected by sensors, then in-path object detection means classifying detected objects in two categories: in-path object and out-of-path object. An object can be said to be in-path if it can be in the path of ego vehicle. In FIG. 3, T₁ can be in-path object while T₂ can not be. Availability of high resolution maps with information about static objects on road like lane markings, speed limits, buildings, and curvature of the road has made it possible to incorporate them in localization and detection. The major sources of error in this approach can be localization error and errors in range and angle of detected object. In the course of this discussion, tracking means measuring range, azimuth angle and relative velocity of detected object. Uncertainties in tracking means uncertainty in range, azimuth angle and relative velocity of the object in ego vehicle's frame. The maps cannot be used for localization and detection without conducting comprehensive and rigorous analysis of the major sources of uncertainties.

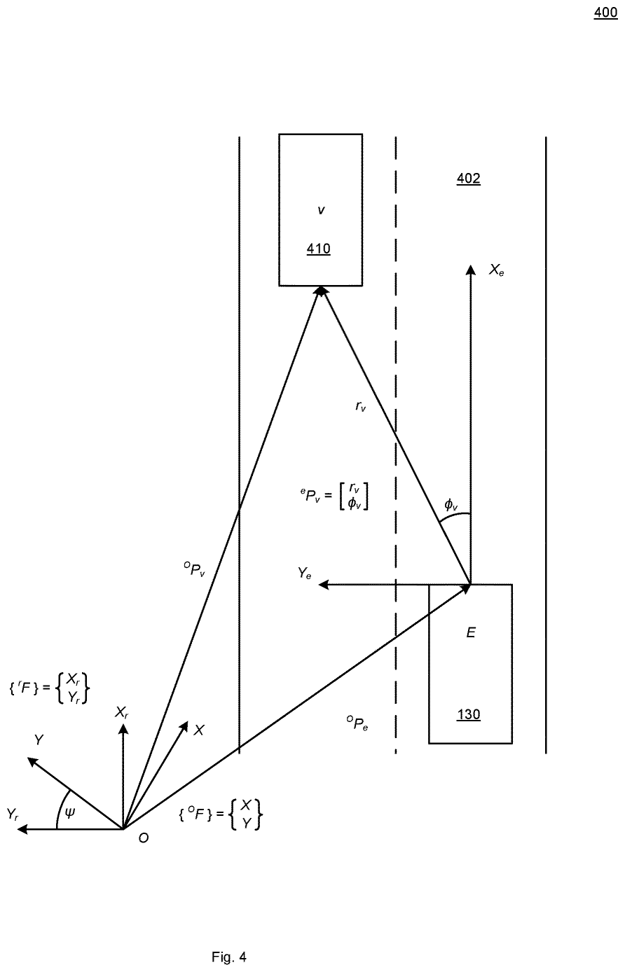

FIG. 4 illustrates a detection by a system in accordance with present implementations. As illustrated by way of example in FIG. 4, an example detection 400 can include the ego vehicle 130, a path 402, and a second vehicle 410. For example, FIG. 4 can be directed to a frame definition.

Uncertainty in localization can be considered and it can be assumed that the sensor data can be reliable. However, the uncertainty in sensor data can be very important. Even a small error in the angle results in large error in the lateral measurement. To determine the lane-level information of the detected object, the error in the sensor data has to be considered. Therefore, the uncertainty in localization as well as the uncertainty in detection of the object can be considered in analysis. An evidential framework can be proposed. This application presents a maximum likelihood estimation for lane estimation along with quantification of confidence level in determining the lane of the object in the presence of localization and detection noise. Suppose this yields a map with complete road geometry and lane-level information e.g., the lane information of each point on the map can be accurately known. Let {^{O}F} and {^{e}F} be the global frame and ego vehicle frame respectively (FIG. 4). Let θ be the angle of rotation of {^{e}F} with respect to {^{O}F} and it represents the heading of the ego vehicle. The position of the ego vehicle in {^{O}F} can be given by ^{O}Pₑ=[^{O}xₑ ^{O}yₑ]. Let ^{e}Pᵥ=[rᵥ cos (φᵥ) rᵥ sin (φᵥ)]^{T} be the position of an object v detected by sensors with respect to {^{e}F}. Let {^{r}F} be another frame whose center coincides with {^{O}F} and its angle of rotation can be ψ with respect to {^{O}F}. Here ψ represents the heading of the road at position ^{O}Pᵥ. A goal can be to find the lane in which v can be located. The rotation matrices ^{O}Rₑ and ^{r}R_{O} can be given by the equation

$${}^{O} {R}_{e} = [ \begin{matrix}cos θ & - sin θ \\ sin θ & cos θ\end{matrix} ] ; {}^{r} {R}_{O} [ \begin{matrix}cos ψ & sin ψ \\ - sin ψ & cos ψ\end{matrix} ] . \qquad ( 1 )$$

Let ^{O}Pᵥ be the position of obstacle in {^{O}F} and it can be given by

$${}^{O} {P}_{v} = [ \begin{matrix}{}^{O} {x}_{v} \\ {}^{O} {y}_{v}\end{matrix} ] = {}^{O} {R}_{e} {}^{e} {R}_{v} + {}^{O} {R}_{e} , \qquad ( 2 )$$

$${}^{O} {P}_{v} = [ \begin{matrix}c o s ( θ + {ϕ}_{v} \\ sin ( θ + {ϕ}_{v} )\end{matrix} ] + [ \begin{matrix}{}^{O} {x}_{e} \\ {}^{O} {y}_{e}\end{matrix} ] .$$

Let ^{r}Pᵥ be the position of obstacle v in {ᵣF} and it can be given by

$${}^{r} {P}_{v} = [ \begin{matrix}{}^{r} {x}_{v} \\ {}^{r} {y}_{v}\end{matrix} ] = {}^{r} {R}_{O} {}^{O} {P}_{v} . \qquad ( 3 )$$

Substituting the values of ^{O}Pᵥ and ^{r}R_{O} from (1) and (2) in (3) Yields

$$[ \begin{matrix}{}^{r} {x}_{v} \\ {}^{r} {y}_{v}\end{matrix} ] = {r}_{v} [ \begin{matrix}cos ( {ϕ}_{v} + θ - ψ \\ sin ( {ϕ}_{v} + θ - ψ\end{matrix} ] + [ \begin{matrix}{}^{O} {x}_{e} cos ψ + {}^{O} {y}_{e} sin ψ \\ {-}^{O} {x}_{e} sin ψ + {}^{O} {y}_{e} cos ψ\end{matrix} ] . \qquad ( 4 )$$

If there can be no error in localization and detection, then ^{O}Pᵥ will provide a deterministic position of v in {^{O}F}. A goal can be to determine the lane of the detected object in the presence of the noise. Suppose that the road contains N lanes and two shoulders, one on each side of the road. The current state of the art sensors fusion techniques can reliably detect whether a detected object can be located on the road or not by the measuring the relative position of the detected object with respect to guardrails, delineators and fences etc. The uncertainty in localization and detection, results in uncertainty in longitudinal position and lateral position of v on the road with respect to frame {^{r}F}. As the concern can be only with estimating the lane of the detected object on the road, therefore the focus will be only on determining the uncertainty in ^{r}yᵥ which can be the lateral position of v on the road with respect to {^{r}F}. First separating ^{r}yᵥ from (4) yields

^{r}yᵥ=rᵥ(sin(φᵥ+θ−ψ)−^{O}xₑ sin ψ+^{O}yₑ cos ψ. (5)

Let rᵥ, φᵥ, θ, ^{O}xₑ, ^{O}yₑ denote the measured values and r̅ᵥ, φ̅ᵥ, θ̅, x̅ₑ, y̅ₑ denote the true values of range, angle, vehicle heading, localization respectively. Similarly, let wᵣ, w_{φ}, w_{θ}, wₓ_{ₑ} and w_{y}_{ₑ} denote the sensor noises in the measurement of the rᵥ, φᵥ, θ, ^{O}xₑ and ^{O}yₑ such that

rᵥ=r̅ᵥ+wᵣ;θ=θ̅+w_{θ},

φᵥ=φ̅ᵥ+w_{φ};^{O}xₑ=x̅ₑ+wₓ_{ₑ},

^{O}yₑ=y̅ₑ+w_{y}_{ₑ};η̅=θ̅+φ̅ᵥ−ψ,

η=η̅+w_{η};w_{η}=w_{θ}+w_{φ}. (6)

Assume zero mean, Gaussian noise in localization as well as detection, e.g.,

$${w}_{i} ∼ 𝒩 ( 0 , {σ}_{i}^{2} )$$

where i∈{xₑ, yₑ, θ, r, φ}. Here

$${σ}_{{x}_{e}}^{2} , {σ}_{{y}_{e}}^{2} , {σ}_{θ}^{2} , {σ}_{r}^{2} and {σ}_{ϕ}^{2}$$

represent the variances of Gaussian noises in ^{O}xₑ, ^{O}yₑ, θ, rᵥ, and φᵥ, respectively. The uncertainties in localization can be captured by σₓ_{ₑ}, σ_{y}_{ₑ} and σ_{θ} and the uncertainty in detection can be captured by σᵣ and σ_{φ}. The localization noise can be denoted by w_{loc}=[wₓ_{ₑ} w_{y}_{ₑ} w_{θ}]^{T}. The detection noise can be denoted by w_{det}=[wᵣ w_{φ}]^{T}. The detection noise w_{det} and localization noise w_{loc} can be independent of each other. The localization uncertainties wₓ_{ₑ}, w_{y}_{ₑ} and w_{θ} can be assumed to be zero mean uncorrelated Gaussian.

Using (6) in (5) yields

^{r}yₑ=(r̅ᵥ+wᵣ)(sin(η̅+wₙ))−(x̅ₑ+wₓ_{ₑ})sin ψ+(y̅ₑ+w_{y}_{ₑ})cos ψ. (7)

The true value of lateral position of v in {^{r}F} can be denoted by ^{r}Yᵥ and it can be given by ^{r}Yᵥ and it can be given by

^{r}Yᵥ=r̅ᵥ(sin(η̅))−(̅^̅{̅O̅}̅x̅ₑ̅)̅sin ψ+(^{O}yₑ)cos ψ. (8)

We can define the error in lateral displacement ^{r}yᵥ as

e_{y}_{ᵥ}=^{r}yᵥ−^{r}Yᵥ. (9)

Using (7) and (8) in (9) and doing some algebraic manipulations yields

e_{y}_{ᵥ}=r̅_{y}(sin(η̅+wₙ)−sin η̅)+wᵣ sin(η̅+wₙ)+w_{y}_{ₑ} cos ψ−wₓ_{ₑ} sin ψ. (10)

The expectation of the error in lateral displacement [symbol] [e_{y}_{ᵥ}] can be given by

[symbol]

[e_{y}_{ᵥ}]= [symbol] [r̅ᵥ sin(η̅+wₙ)−sin η̅]+ [symbol] [w_{y}] cos ψ+ [symbol] [wᵣ sin(η+wₙ)]− [symbol] [wₓ]sin ψ. (11)

If X~ [symbol] (μ, σ²), then [symbol] [sin(X)] can be given by

[symbol]

[sin(X)]=sin(μ)·e^{-σ}^{²}^{/2}. (12)

Using (12) in (11) yields

$$𝔼 [ {e}_{{y}_{v}} ] = {\overline{r}}_{v} sin ( \overline{θ} + \overline{ϕ} - ψ ) ( {e}^{- \frac{1}{2} ( {σ}_{θ}^{2} + {σ}_{ϕ}^{2} )} - 1 ) . \qquad ( 13 )$$

The variance of the error, e.g., [symbol] [e_{y}_{ᵥ}] can be given by

[symbol]

[e_{y}_{ᵥ}]= [symbol] [r̅ᵥ sin(η̅+wₙ)]+ [symbol] [wᵣ sin(η̅+wₙ)]+ [symbol] [w_{y}_{ₑ}]cos²ψ− [symbol] [wₓ_{ₑ}]sin²ψ. (14)

It can be shown that if X~ [symbol] (μ, σ²), then [symbol] [sin(X)] can be given by

$$𝕍 [ sin ( X ) ] = \frac{1}{2} ( 1 - {e}^{- {σ}^{2}} ) ( 1 + {e}^{- {σ}^{2}} cos ( 2 μ ) ) . \qquad ( 15 )$$

As the localization uncertainties w_{θ}, wₓ_{ₑ} and w_{y}_{ₑ} can be uncorrelated and w_{φ}, wᵣ and w_{loc} can be independent, therefore using (15) in (14) and doing some algebraic manipulation yields

$$𝕍 [ {e}_{{y}_{v}} ] = \frac{{\overline{r}}_{v}^{2} + {σ}_{r}^{2}}{2} ( 1 - {e}^{- {σ}_{η}^{2}} ) ( 1 + {e}^{- {σ}_{η}^{2}} cos ( 2 \overline{η} ) ) + {\overline{r}}_{v}^{2} {sin}^{2} ( \overline{η} ) {( {e}^{- \frac{1}{2} {σ}_{η}^{2}} - 1 )}^{2} + {σ}_{{y}_{e}}^{2} {cos}^{2} ( ψ ) - {σ}_{{x}_{e}}^{2} {sin}^{2} ( ψ ) . \qquad ( 16 )$$

For long range applications of radar (more than 200 km), e_{y}_{ᵥ} can be approximated by Maximum Likelihood Gaussian mixture approximation. For short range (r<1 km) applications, e_{y}_{ᵥ} can be approximated as a Gaussian noise with variance

$$𝕍 [ {e}_{{y}_{v}} ] = {σ}_{{e}_{{y}_{v}}} .$$

Let mean and variance of e_{y}_{ᵥ} be denoted by

$${μ}_{{e}_{{y}_{v}}} and {σ}_{{e}_{{y}_{v}}}^{2}$$

respectively such that

$${e}_{{y}_{v}} ∼ 𝒩 ( {μ}_{{e}_{{y}_{v}}} , {σ}_{{e}_{{y}_{v}}}^{2} ) and \qquad ( 17 )$$

$${μ}_{{e}_{{y}_{v}}} = {\overline{r}}_{v} sin ( \overline{θ} + {\overline{ϕ}}_{v} - ψ ) ( {e}^{- \frac{1}{2} ( {σ}_{θ}^{2} + {σ}_{ϕ}^{2} )} - 1 ) ,$$

$${σ}_{{e}_{{y}_{v}}}^{2} = \frac{{\overline{r}}_{v}^{2} + {σ}_{r}^{2}}{2} ( 1 - {e}^{- {σ}_{η}^{2}} ) ( 1 + {e}^{- {σ}_{η}^{2}} cos ( 2 \overline{η} ) ) ++ {\overline{r}}_{v}^{2} {sin}^{2} ( \overline{η} ) {( {e}^{- \frac{1}{2} {σ}_{η}^{2}} - 1 )}^{2} + {σ}_{{y}_{e}}^{2} {cos}^{2} ( ψ ) - {σ}_{{x}_{e}}^{2} {cos}^{2} ( ψ ) .$$

The above equation (17) captures both localization and detection uncertainties and describe them in a compact form. Some interesting observations can be made from (17). If r can be very large then even small error in the heading angle θ and φ would result in large uncertainties in lateral position. Now ^{r}yᵥ can be modeled as a Gaussian random variable as follows:

$${r}^{} {y}_{v} = {r}^{} {Y}_{v} + {e}_{{y}_{v}} , \qquad ( 18 )$$

$${e}_{{y}_{v}} ∼ 𝒩 ( {μ}_{{e}_{{y}_{v}}} , {σ}_{{e}_{{y}_{v}}}^{2} ) .$$

Decision Criteria for In-Path Detection. Assume that the road has N lanes and two shoulders, one on each side of the road. The lane markings at a distance can be denoted by rᵥ from the ego vehicle by the set l(rᵥ)={l₋₁, l₀, l₁, . . . , l_{N}, l_{N+1}}. The lane Lᵢ can be represented by lateral position of the lane [lᵢ₋₁, lᵢ] with respect to the frame {^{r}F}. The shoulders of the road can be marked by [l₋₁, l₀] and [l_{N}, l_{N+1}]. Let Lₑ denotes the lane of the ego vehicle. Let Lᵥ and \hat{L}ᵥ be the actual lane and estimated of the detected object v respectively. Let the estimated value of ^{r}Yᵥ be denoted by [symbol] Now the maximum likelihood estimator of ^{r}Yᵥ can be given below

$$\text{?} ( {r}^{} {y}_{v} ) = arg {max}_{{r}^{} {Y}_{v}} p ( {r}^{} {y}_{v} \vert {r}^{} {Y}_{v} ) = arg {max}_{{r}^{} {Y}_{v}} - {( {r}^{} {y}_{v} - {r}^{} {Y}_{v} - {μ}_{{e}_{{y}_{v}}} )}^{2} \qquad ( 19 )$$

$$\text{?} ( {r}^{} {y}_{v} ) = {r}^{} {y}_{v} - {μ}_{{e}_{{y}_{v}}} \qquad ( 20 )$$

$$if {l}_{i - 1} \leq \text{?} \leq {l}_{i} ⇒ {\hat{L}}_{v} = {L}_{i}$$

If \hat{L}ᵥ=Lₑ then v can be estimated to be in the path lane of the ego vehicle. If \hat{L}ᵥ≠Lₑ, then v cannot be in the path lane of the ego vehicle according to our ML decision criteria. The detected object can be equally likely to be in any lane, e.g., the lateral distance ^{r}Yᵥ can be uniformly distributed in the interval [l₋₁, l_{N+1}]. Now, the probability that the detected object v lies in the path lane of the ego vehicle given that ^{r}yᵥ can be measured by the sensor. This probability can be denoted by Pᵢₙ₋ₚₐₜₕ and it can be given by

$${P}_{in - path} = p ( {l}_{e - 1} ) < {r}^{} {Y}_{v} < {l}_{e} \vert {r}^{} {y}_{v} = \frac{{\int }_{{l}_{e - 1}}^{{l}_{e}} p ( {r}^{} {y}_{v} \vert {r}^{} {Y}_{v} ) p ( {r}^{} {Y}_{v} ) d {r}^{} {Y}_{v}}{{\int }_{{l}_{- 1}}^{lN + 1} p ( {r}^{} {y}_{v} \vert {r}^{} {Y}_{v} ) p ( {r}^{} {Y}_{v} ) d {r}^{} {Y}_{v}} = \frac{{\int }_{{l}_{e - 1}}^{{l}_{e}} p ( {r}^{} {y}_{v} \vert {r}^{} {Y}_{v} ) {d}^{r} {Y}_{v}}{{\int }_{{l}_{- 1}}^{lN + 1} p ( {r}^{} {y}_{v} \vert {r}^{} {Y}_{v} ) {d}^{r} {Y}_{v}} . \qquad ( 21 )$$

Evaluating the integral in the above equation yields

$${P}_{in - path} = \frac{erf [ g ( {l}_{e} , {r}^{} {y}_{v} ) ] - erf [ g ( {l}_{e - 1} , {r}^{} {y}_{v} ) ]}{erf [ g ( {l}_{N + 1} , {r}^{} {y}_{v} ) ] - erf [ g ( {l}_{- 1} , {r}^{} {y}_{v} ) ]} , \qquad ( 22 )$$

$$where g ( k , y ) = ( \frac{k - {μ}_{{ey}_{v}} - y}{\sqrt{2 {σ}_{{ey}_{v}}^{2}}} ) .$$

The MLE decision criteria to estimate the lane of the object v can be given by (19). The probability that v can be located in the ego vehicle's path lane Lₑ given that ^{r}yᵥ can be measured, can be calculated from (22). Finally, the desired velocity can be defined as V_{des} of the ego vehicle in terms of the probability Pᵢₙ₋ₚₐₜₕ (22). Let the velocity of the detected object be Vₗ and the velocity of the ego vehicle be V_{f}. Suppose that according to the MLE estimator defined in (19), the detected object v can be estimated to be in the path lane of the ego vehicle. Let the maximum optimal velocity limit be V_{effective} which ensures collision avoidance with objects not visible by the ego vehicle's on-board sensors. The V_{effective} depends on sensor's range, field of view of sensors, road curvature, slope, superelevation, lane-width, weather and road conditions. The desired velocity of the ego vehicle V_{des} can be given by

$${V}_{des} = \{ \begin{matrix}( 1 - {P}_{in - path} ) {V}_{safe} & if {V}_{l} = 0 \\ min ( {P}_{in - path} {V}_{i} , {V}_{safe} ) & if {V}_{l} > 0\end{matrix} . \qquad ( 23 )$$

If the detected object can be stationary, e.g., Vₗ=0 then 0≤V_{des}≤V_{effective} depending on Pᵢₙ₋ₚₐₜₕ. If the probability Pᵢₙ₋ₚₐₜₕ can be high then the V_{des} can be reduced more. If the probability Pin-path can be low then the desired velocity V_{des} reduced by a small amount. When the detected object has velocity Vl then the desired velocity V_{des}=min (Pᵢₙ₋ₚₐₜₕVₗ, V_{effective}). When the ego vehicle approaches the object then Pᵢₙ₋ₚₐₜₕ increases or decreases depending upon v's position on the road with respect to the ego vehicle and V_{des} can be adjusted accordingly.

The Vₗ, Pᵢₙ₋ₚₐₜₕ and Xᵣ (distance between ego vehicle and nearest in-path object) can be the outputs of the In-Path Object Detection and Tracking module. These outputs can be fed into the next module. For example, this technical solution can find maximum optimal velocity limit V_{effective} for all road geometric conditions that ensures limited lateral acceleration and collision avoidance with all potential obstacles during both the cruising mode and the vehicle following mode.

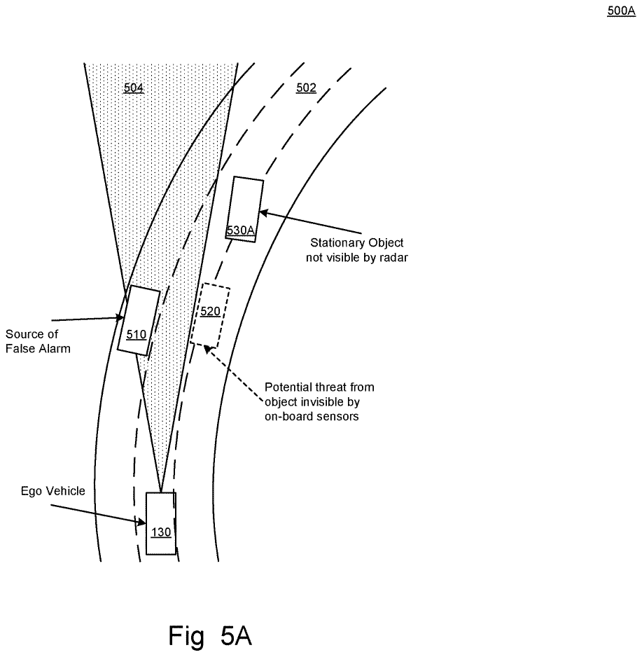

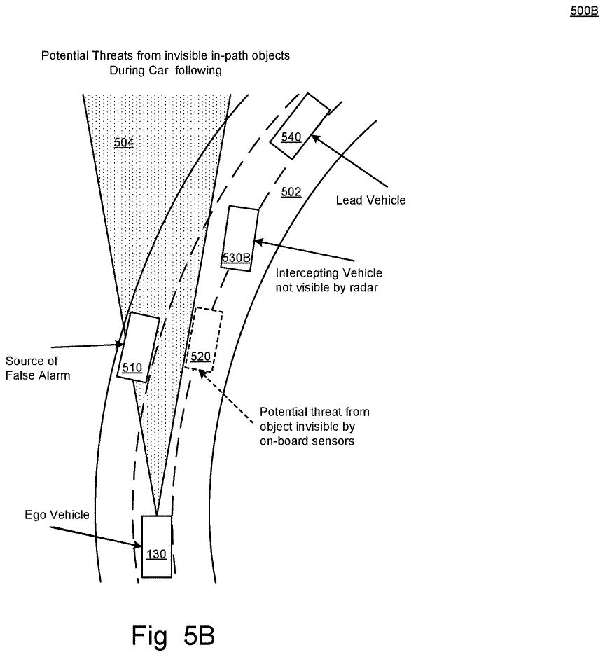

FIG. 5A illustrates a detection in a first example environment in accordance with present implementations. As illustrated by way of example in FIG. 5A, an example environment 500A can include the ego vehicle 130, a path 502, a sensor detection area 504, a first object 510, a second object 520, and a third object 530A. For example, FIG. 5A can be directed to detection of potential threats from in-path objects not visible by on-board sensors.

FIG. 5B illustrates a detection in a second example environment in accordance with present implementations. As illustrated by way of example in FIG. 5B, an example environment 500B can include the ego vehicle 130, the path 502, the sensor detection area 504, the first object 510, the second object 520, a third object 530B, and a fourth object 540. For example, FIG. 5B can be directed to detection of potential threats from in-path objects not visible by on-board sensors.

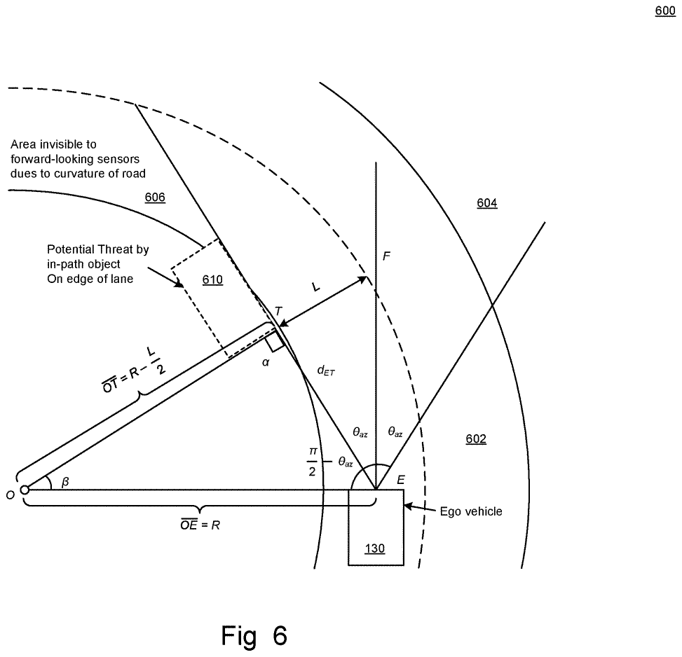

FIG. 6 illustrates a detection in a third example environment in accordance with present implementations. As illustrated by way of example in FIG. 6, an example environment 600 can include the ego vehicle 130, a path 602, a sensor detection area 604, a curvature portion 606 of the path 602, and a first object 510. For example, FIG. 6 can be directed to an effective range of a sensor on a curved path.

For example, this technical solution can find the optimal velocity limit as a function of road geometry (curvature, slope, superelevation), road friction, field of view of radar, maximum lateral and longitudinal acceleration. First, find the maximum range of the on-board sensors in terms of the road geometry and the field of view of the sensors. Then, find the optimal velocity that ensures collision avoidance and limited lateral acceleration. A preemptive spacing requirement can be defined that will ensure collision avoidance for all road geometric conditions.

In FIG. 5, the ego vehicle can be shown in various scenarios. Due to the curvature of the road, the on-board sensors cannot detect the potential threat posed by the possible slow moving or stationary obstacle. A goal can be to find the optimal speed limit and optimal spacing requirements from possible potential threat. On the straight road, the range of the sensor can be large enough to provide a performance spacing to ensure that if there can be an object in the ego vehicle's lane then it can be detected in time. But on curved roads the range of the sensors decreases. First, find the effective range of the sensors on curved path. It can be assumed that a potential stationary obstacle can be present just outside the effective range of the on-board sensors. This distance will help reduce the speed at a certain level in order to maintain performance till more information becomes available by the sensors.

Let X_{effective} denote the optimal spacing distance from potential threats on a curved road. Let d_{R} be the range of a sensor on a straight path, θ_{az} be the maximum azimuth angle of the radar or any other sensor and field of view=2θ_{az}. Normally d_{R} can be in hundreds of meters range which can be enough for straight roads scenarios for object detection and collision avoidance. On curved road, the sensor's range decreases due to the curvature of the road. This new effective range, d_{ER}, can be defined as the maximum range of the sensor at which an object on the vehicle's path can be detected on a curvature c=1/R. When c=0, e.g., R=∞, the effective range d_{ER}=d_{R}. When the curvature c>0, the effective range d_{ER}<d_{R}. The objects that can be normally visible on a straight path, may become invisible by on-board forward-looking sensors on a curved path.

Similarly, if the field of view can be too small, then sensors cannot cover the whole cross section of the road, thereby leaving blind spots. In FIG. 6, ego vehicle E can be travelling on a curved path of radius R. Here field of view can be 2θaz. When θ_{az}<θ_{az,min}, the objects near the edge of the lane can be at least partially undetectable by the on-board sensors. Therefore if ego vehicle lane can be travelling on a curve of radius R, the required minimum field of View=2θ_{az,min} can be given by

$${θ}_{az , min} = {cos}^{- 1} ( \frac{R - \frac{L}{2}}{R} ) . \qquad ( 24 )$$

When θ_{az}=θ_{az,min}, then α=π/2. In FIG. 6, d_{ET} can be the distance between ego vehicle and stationary object at the edge of the curve, θ_{az} can be the angle ∠FET. When θ_{az}≥θ_{az,min}, then the d_{ET} can be given by

$${d}_{ET} = \sqrt{{R}^{2} + {( R - \frac{L}{2} )}^{2} - 2 R ( R - \frac{L}{2} )} cos β , \qquad ( 25 )$$

$$where$$

$$β = \frac{π}{2} + {θ}_{az} - {sin}^{- 1} ( \frac{R}{R - \frac{L}{2}} cos {θ}_{az} ) . \qquad ( 26 )$$

Let d_{ER} be the effective range of sensor with field of view=2θ_{az} on road of curvature R and lane width L. The effective range d_{ER} can be given by

d_{ER}=min(d_{R},d_{ET}). (27)

The maximum sensor range d_{R} can be taken as 300 m and lane width L=3.6576 m.

After calculating the effective range of sensors along curved path, the speed limit can be found subject to the radius R, slope α, road grade G=tan α, superelevation e, and lane width L to limit acceleration as well as to avoid collision with objects just outside the effective range of on-board sensors. The grade G can be positive for uphill and negative for downhill. A limit of lateral acceleration for passengers' comfort can be a_{y,max}=0.2 g m/s². The design velocity on a curved road with superelevation e and coefficient of side friction fₛ can be given by V=\sqrt{gR(e+fₛ)}. The lateral acceleration of a body moving with speed V_{f} on a curved path can be given by

$${a}_{y} = {V}_{f}^{2} / R .$$

### Therefore

$${V}_{f} \leq min [ {( gR ( e + {f}_{s} ) )}^{\frac{1}{2}} , {( {a}_{y , max} R )}^{\frac{1}{2}} ] .$$

The sensors can detect objects up to the effective range d_{ER}. The objects outside the effective range can be invisible. The objects can be detected by the on-board sensors when the relative distance between the ego vehicle and the detected object Xᵣ≤d_{ER}. Moreover, the objects on the lane can be moving or stationary. As a worst-case scenario, it can be assumed that there can be a stationary object on the ego vehicle's lane just outside the effective range of the on-board sensors.

Now, the maximum speed can be found such that the controller can stop the vehicle at an optimal distance from a potential in-path object that can be invisible to on-board sensors. The maximum braking acceleration can be denoted by a_{x,max}, the coefficient of friction by μ and the lateral forces by F_{y}. On a straight road, the maximum braking capability can be larger than the braking capability while vehicle can be moving on a curved path. The reason for this can be that the vector sum of forces generated during braking cannot exceed the μF_{z}. Where F_{z} can be the force on tires in direction of fixed body z-axis. The limit on longitudinal acceleration can be given by

$${a}_{x , max} = \frac{\sqrt{{( μ mg )}^{2}} - {( \sum {F}_{y} )}^{2}}{m} . \qquad ( 28 )$$

The lateral forces can be calculated in real-time or estimated based on various models. The longitudinal acceleration x and the lateral acceleration a_{y} can be related to each other in a limited friction circle such that

$${a}_{x}^{2} + {a}_{y}^{2} = {F}_{c}^{2} , \qquad ( 29 )$$

where F_{c} can be a positive variable, and it depends on the slip angle. The maximum longitudinal acceleration a_{x,max} can be given by

$${a}_{x , max} = \sqrt{{F}_{c}^{2} - {a}_{y , max}^{2}} . \qquad ( 30 )$$

The maximum longitudinal braking capability significantly decreases during combined lateral and longitudinal motion. Now, the maximum optimal velocity can be denoted by V_{effective} and optimal distance from potential in-path object as X_{effective}=d_{ER}. The maximum optimal velocity can be given by

$${V}_{safe} = min ( {( gR ( e + {f}_{s} ) )}^{\frac{1}{2}} , {( {a}_{y , max} R )}^{\frac{1}{2}} , \qquad ( 31 )$$

$${( 2 ( {a}_{x , max} + gG ) {X}_{safe} )}^{\frac{1}{2}} ) .$$

In (31), V_{effective} can be the maximum speed allowed by the controller to avoid collisions with objects just outside the range of on-board sensors and to limit the lateral acceleration below a_{y,max}. If the curvature changes on a curved road, then the maximum road curvature can be used to find the maximum optimal velocity V_{effective}.

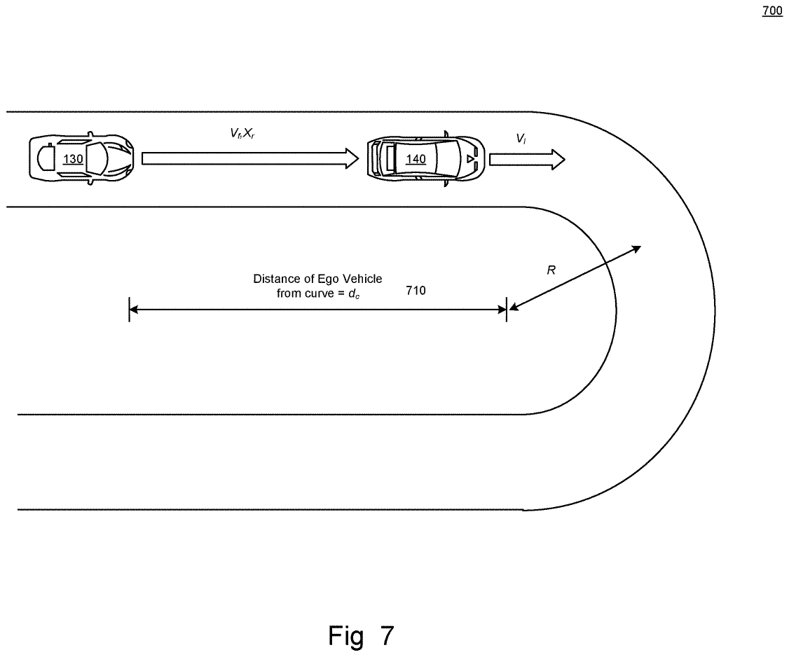

FIG. 7 illustrates a detection in a fourth example environment in accordance with present implementations. As illustrated by way of example in FIG. 7, an example environment 700 can include the ego vehicle 130 and the lead vehicle 140 at a distance 710. For example, FIG. 7 can be directed to an ego vehicle transitioning from a straight road to a curved road.

One important scenario that needs special consideration can be the transition from a straight road to a curved road. When the ego vehicle approaches a curve, it must, preemptively, adjust its speed and enter the curved path at V_{f}≤V_{effective}. Consider the scenario in FIG. 7. Suppose that the ego vehicle can be cruising or following a lead vehicle on a straight path and the lead vehicle's velocity Vₗ>>V_{effective}. If, before entering the curve, the ego vehicle velocity V_{f}>>V_{effective} then ego vehicle needs to apply high deceleration in order to reach V_{effective}. This large deceleration could cause discomfort to the passengers. Since the radius of the curve can be known due to the availability of high resolution maps, the geometric level information of the road can be incorporated for smooth transition from the straight road to the curved road as follows. Let the distance of the ego vehicle from the curve be d_{c}≥0, and the optimal velocity limit for the curve be V_{effective,c}. Let a_{x,comf} be the comfortable braking deceleration. Let V_{effective,s} be the optimal speed limit for an ego vehicle on a straight road at a distance d_{c} from a curved road of radius R, then yields:

$${V}_{safe , s} = {[ {V}_{safe , c}^{2} - 2 \cdot ( {a}_{x , comf} + gG ) \cdot {d}_{c} ]}^{\frac{1}{2}} .$$

Studies have shown that for the majority of drivers the comfortable deceleration can be a_{x,comf}=3 m/s⁻². In rural areas a_{x,comf}=2 m/s⁻². Depending upon the road conditions, a_{comf} can be chosen appropriately. The speed limit on the road segment under consideration can be denoted by Vₘₐₓ. Now V_{effective,s} can be given by the equation

$${V}_{safe , s} = min ( {V}_{max} , {[ {V}_{safe}^{2} - 2 \cdot ( {a}_{x , comf} + gG ) \cdot {d}_{c} ]}^{\frac{1}{2}} ) .$$

The optimal speed limit V_{effective,s} on a straight road can be a function of dc and it ensures that the ego vehicle smoothly transitions from a straight road to a curved road. Let V_{effective,c}, V_{effective,s} be the optimal speed limits and X_{effective,c} and X_{effective,s} be the optimal distance from the potential obstacles on the curved road and the straight road respectively and they can be given by

$${X}_{safe , c} = min ( {d}_{R} , {d}_{ER} ) , {X}_{safe , s} = {d}_{c} + {X}_{safe , c} , \qquad ( 32 )$$

$${V}_{safe , c} = min ( {( gR ( e + {f}_{s} ) )}^{\frac{1}{2}} , {( {a}_{y , max} R )}^{\frac{1}{2}} , {( w ( {a}_{x , max} + gG ) {X}_{safe} )}^{\frac{1}{2}} ) ,$$

$${V}_{safe , s} = min ( {V}_{max} , {[ {V}_{safe , c}^{2} - 2 ( {a}_{comf} + gG ) {d}_{c} ]}^{\frac{1}{2}} ) .$$

As the ego vehicle transitions from the straight road to a curved road, the distance d_{c}→0 and V_{effective,s}→V_{effective,c}. When d_{c}=0 then V_{effective,s}=V_{effective,c}. Let X_{effective} and V_{effective} be the optimal spacing and optimal velocity for all road scenarios. Now X_{effective} and V_{effective} can be given by

$${V}_{safe} = \{ \begin{matrix}{V}_{safe , s} & if R = ∞ \\ {V}_{safe , c} & if R < ∞\end{matrix} , \qquad ( 33 )$$

$${X}_{safe} = \{ \begin{matrix}{X}_{safe , s} & if R = ∞ \\ {X}_{safe , c} & if R < ∞\end{matrix} , \qquad ( 34 )$$

Depending on the road geometry, the optimal speed limit V_{effective} can be chosen to ensure collision avoidance with potential in-path objects.

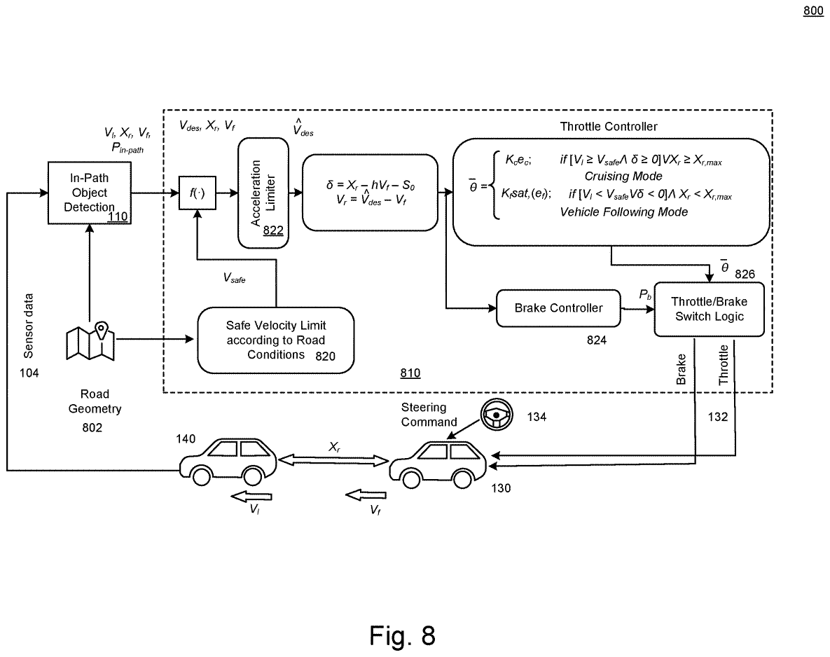

FIG. 8 illustrates a method of automatic vehicle following under predetermined preference parameters and road geometry conditions in accordance with present implementations. As illustrated by way of example in FIG. 8, an example method 800 can include a system or device 810 to perform one or more of steps 820, 822, 824 and 826 based on the sensor data 104, the detection system 110, and road geometry 802. The method 800 can perform actions with respect to one or more of the ego vehicle 130 and the lead vehicle 140 by the commands 132 and 134. For example, FIG. 8 can be directed to a controller for optimal vehicle following and a cruising system.

For example, this technical solution can include a controller for the automatic vehicle following and cruising system under performance and comfort constraints. The throttle model and brake model can be given by

$${\dot{V}}_{f} = \{ \begin{matrix}- a ( {V}_{f} - {V}_{des} ) + b ( θ - {θ}_{0} ) & Throttle Dynamics , \\ \frac{1}{m} ( {α}_{1} {T}_{b} - {f}_{0} - {α}_{2} {V}_{f} - & Brake Dynamics . \\ {α}_{3} {V}_{f}^{2} - mg sin ( α ) ) & \end{matrix}$$

In the above equation, throttle model can be a linearized model in which a>0, b>0 can be system parameters, θ denotes the throttle angle, θ₀ denotes the throttle angle required to maintain desired speed V_{des}. The value of θ₀ for each V_{des} comes from a lookup table. In the above equation, m denotes the mass of vehicle, f₀ denotes the static friction, α₁T_{b} denotes the force from the braking torque, α₂ denotes the coefficient of rolling friction, α₃ denotes the coefficient of aerodynamic drag, and a denotes the slope of the road. The control objectives can be given below:

$${V}_{des} = \{ \begin{matrix}{V}_{safe} & Cruising Mode \\ min ( {V}_{l} , {V}_{safe} ) & Vehicle Following Mode\end{matrix}$$

$${V}_{r} \to 0 , {V}_{r} = {V}_{des} - {V}_{f} ,$$

$$δ \to 0 , δ = {X}_{r} - {hV}_{f} - {S}_{0} ,$$

$${a}_{y} \leq {a}_{y , max} , {a}_{x , min} \leq {V}_{f} \leq {a}_{x , max} .$$

In the above equation, V_{des} denotes the desired speed of the go vehicle, V_{effective} denotes the optimal speed limit. The V_{f} and Vₗ denote the velocities of the ego vehicle and the lead vehicle respectively. The Xᵣ denotes the relative spacing between the lead vehicle and the ego vehicle, h>0 denotes the constant time headway, S₀>0 denotes the optimal distance between lead vehicle and ego vehicle at rest position. The longitudinal acceleration and the lateral acceleration of the ego vehicle can be denoted by aₓ and a_{y} respectively. The limits on the longitudinal acceleration of the ego vehicle can be denoted by a_{x,max} and a_{x,min} where a_{x,min}=−a_{x,max}. During the cruising mode, a goal can be to track V_{effective}. During the vehicle following mode, a goal can be to track min (Vₗ, V_{effective}) while keeping an optimal spacing. The system switches to the cruising mode when the proposition P_{c} given by

P_{c}: [Vₗ≥V_{safe}∧δ≥0]∨Xᵣ≥X_{r,max}, (35)
holds, where X_{r,max} denotes the maximum relative spacing required for switching. The vehicle following mode can be selected when the proposition P_{f} given by

P_{f}: [Vₗ<V_{safe}∨δ<0]∧Xᵣ<X_{r,max}, (36)
holds. Switching from the cruising mode to the vehicle following mode produces large spacing error which could produce large acceleration. This issue can be solved by including the saturation limit on the spacing error. The following controller can be used in vehicle following mode. It contains a throttle controller, a brake controller, a throttle/brake switching logic and a saturation logic. The throttle controller can be given by

$$\overline{θ} = θ - {θ}_{0} , \qquad ( 37 )$$

$$sat ( δ ) = \{ \begin{matrix}{δ}_{min} & if δ < {δ}_{min} \\ δ & if {δ}_{min} \leq δ \leq {δ}_{max} \\ {δ}_{max} & if δ > {δ}_{max}\end{matrix} ,$$

$${\hat{V}}_{l} = \{ \begin{matrix}{a}_{x , min} & if p ( {V}_{l} - {\hat{V}}_{l} ) < {a}_{x , min} \\ p ( {V}_{l} - {\hat{V}}_{l} ) & if {a}_{x , min} \leq p ( {V}_{l} - {\hat{V}}_{l} ) \leq {a}_{x , max} \\ {a}_{x , max} & if p ( {V}_{l} - {\hat{V}}_{l} ) > {a}_{x , max}\end{matrix} ,$$

$$\overline{θ} = {k}_{1} ( {\hat{V}}_{l} - {V}_{f} ) + {k}_{2} sat ( δ ) + {\int }_{0}^{t} {k}_{3} ( {\hat{V}}_{l} - {V}_{f} ) + {k}_{4} sat ( δ ) dt .$$

The brake controller can be given by

$$u = {\dot{V}}_{f} = \frac{1}{M} ( - {α}_{1} {T}_{b} - {f}_{0} - {α}_{2} {V}_{f} - {α}_{3} {V}_{f}^{2} - Mg sin ( γ ) ) ,$$

$$u = {β}_{1} {V}_{r} + {β}_{2} δ ,$$

Let P_{b} be the brake line pressure. For example, P_{b} can depend on the braking torque T_{b} such that

$${P}_{b} = \frac{{α}_{1} {T}_{b}}{{α}_{4}} ,$$

where α₄ can be a positive constant. Since the available acceleration can be limited between α_{x, min}≤aₓ≤a_{x,max}, the brake line pressure can be given by

$${P}_{b} = \{ \begin{matrix}{P}_{b , 1} & if C 1 is satisfied \\ {P}_{b , 2} & if C 2 is satisfied \\ {P}_{b 0} & otherwise\end{matrix} , \qquad ( 38 )$$

$${P}_{b , 1} = 0 ,$$

$${P}_{b , 2} = \frac{1}{{α}_{4}} [ M {α}_{x , min} + {f}_{0} + {α}_{2} {V}_{f} , + {α}_{3} {V}_{f}^{2} - Mg sin ( γ ) ] ,$$

$${P}_{0} = - \frac{1}{{α}_{4}} [ M ( {β}_{1} {V}_{r} + {B}_{2} sat ( δ ) ) + {f}_{0} + {α}_{2} {V}_{f} + {α}_{2} {V}_{f} + {α}_{3} {V}_{f}^{2} - Mg sin ( γ ) ] ,$$

where C1 and C2 can be given by

$$C 1 : - M ( {β}_{1} {V}_{r} + {β}_{2} sat ( δ ) ) < {f}_{0} + {α}_{2} {V}_{f} + {α}_{2} {V}_{f}^{2} - Mg sin ( γ ) , \qquad ( 39 )$$

$$C 2 : {β}_{1} {V}_{r} + {B}_{2} sat ( δ ) < {α}_{x , min} .$$

Switching between throttle and brake controller can be governed by the following example switching logic. For example, when Xr<Xmin∧Vf>Vdes holds, then the brake controller can be switched ON and the throttle can be switched OFF. For example, when Xr>Xmax, then the throttle controller can be switched ON and the brake controller can be switched OFF. For example, when Xₘᵢₙ≤Xᵣ≤Xₘₐₓ ∧(V_{f}≤V_{des}∧Xᵣ<Xₘᵢₙ) holds, then the switching logic retains its previous position. If the brake controller was ON, then it will remain ON and if it was OFF then it will remain OFF. This region introduces a hysteresis during the switching process. This hysteresis prevents frequent switching between throttle and braking controller under all practical situations.

The throttle controller and brake controller can meet all vehicle following objectives in a straight road scenario. For example, the above controller can be modified to have optimal vehicle following and cruising under all road geometries.

Yields calculated the optimal speed limit V_{effective} which ensures collision avoidance from potential objects not visible to on-board sensors due to the curvature of the road. Moreover an MLE decision criteria (19) can be presented to determine the lane of the lead vehicle in the presence of localization and detection uncertainty. The uncertainty in determining the lane of the detected lead vehicle can be quantified as Pᵢₙ₋ₚₐₜₕ (22). For example, the above controller can be modified to have an optimal vehicle following and cruising under all road geometries and adverse weather conditions. Suppose that Lₑ be the lane of the ego vehicle. Suppose that m objects, denoted by {n₁, n₂, . . . , nₘ}, can be detected by on-board sensors. For each detected object nᵢ, the estimated lane \hat{L}ᵢ, probability Pᵢ that nᵢ can be in the ego vehicle's path lane, speed Vᵢ and relative distance X_{r,i} can be measured. Let S be the set of all in-path objects.

S={nᵢ|\hat{L}ᵢ=Lₑ∀1≤i≤n} (40)

Let nₗ be the nearest in-path object with probability Pₗ, relative distance Xᵣ and speed Vₗ. Now the desired velocity

$${V}_{des} = f ( {( {V}_{i} , {P}_{i} , {X}_{r , i} )}_{i = 1}^{i = m} , {V}_{safe} )$$

can be given by

$${V}_{des} = f ( {( {V}_{i} , {P}_{i} , {X}_{r , i} )}_{i = 1}^{i = m} , {V}_{safe} ) , \qquad ( 41 )$$

$${n}_{l} = {arg min}_{{n}_{1} ∈ S} {X}_{r , i} ,$$

$${V}_{des} = \{ \begin{matrix}( 1 - max ( {P}_{1} , {P}_{2} , … , {P}_{m} ) ) {V}_{safe} & if S = ∅ \\ \{ \begin{matrix}{P}_{l} {V}_{safe} & \begin{matrix}if {P}_{c} \cdot {\overline{P}}_{f} = 1 \\ Cruising Mode\end{matrix} \\ min ( {P}_{l} {V}_{l} , {V}_{safe} ) & \begin{matrix}if {\overline{P}}_{c} \cdot {P}_{f} = 1 \\ Vehicle Following Mode .\end{matrix}\end{matrix} & if S \neq ∅\end{matrix}$$

When no object can be detected in the ego vehicle lane, e.g., S=Ø then the desired velocity can be V_{des}=(1−max(P₁, P₂, . . . , Pₘ))V_{effective}. When S≠Ø, then the nearest in-path object nₗ can be considered as the lead vehicle with speed Vₗ, relative distance Xᵣ and probability Pₗ. The desired velocity can be V_{des}=PₗV_{effective} during the cruising mode and V_{des}=min(PₗVₗ, V_{effective}) during the vehicle following mode. The controller in (37) can be modified in the following way. The saturation on the spacing error δ can be modified as follows.

$$sat ( δ ) = \{ \begin{matrix}δ & if δ \leq {δ}_{max} \\ {δ}_{max} & if δ \leq {δ}_{max}\end{matrix}$$

The throttle controller has two modes: vehicle following mode and vehicle cruising mode. The vehicle following mode can be selected when P_{f} can be true and P_{c} can be false. The cruising mode can be selected P_{c} can be true and P_{f} can be false. The throttle controller for vehicle following mode and cruising mode along with the switching logic can be given by

$${K}_{c} = ( \begin{matrix}{k}_{c , 1} & {k}_{c , 2}\end{matrix} ) , ; {K}_{f} = ( \begin{matrix}{k}_{f , 1} & {k}_{f , 2} & {k}_{f , 3}\end{matrix} ) , \qquad ( 42 )$$

$${e}_{c} = ( \begin{matrix}{V}_{r} \\ {\int }_{0}^{t} {V}_{r} dt\end{matrix} ) , {e}_{f} = ( \begin{matrix}{V}_{r} \\ δ \\ {\int }_{0}^{t} ( {k}_{a} {V}_{r} + {k}_{b} sat ( δ ) ) dt\end{matrix} ) ,$$

$$\overline{θ} = \{ \begin{matrix}{K}_{c} {e}_{c} & \begin{matrix}Cruising Mode \\ {P}_{c} \cdot {\overline{P}}_{f} = 1\end{matrix} \\ {K}_{f} sat ( {e}_{f} ) & \begin{matrix}Vehicle Following Mode : \\ {\overline{P}}_{c} \cdot {P}_{f} = 1\end{matrix}\end{matrix} .$$

In throttle control design for the vehicle following mode, λ=−10, ζ=0.9 and ωₙ=0.2 can be selected. A large ζ=0.9 can be selected to avoid a large overshoot in Vᵣ. In the cruising mode, the controller can be designed by selecting two negative real poles λ=−2,−4. FIG. 8, describes the complete vehicle following and cruising system that ensures comfort and performance under sensor error and road geometry conditions. The complete throttle controller can be summarized by

$${V}_{safe} = \{ \begin{matrix}{V}_{safe , s} & if R = ∞ \\ {V}_{safe , c} & if R < ∞\end{matrix} ,$$

$${V}_{des} = f ( {( {V}_{i} , {P}_{i} , {X}_{r , i} )}_{i = 1}^{i = m} , {V}_{safe} ) ,$$

$${\dot{\hat{V}}}_{des} = \{ \begin{matrix}{α}_{x , max} & if p ( {V}_{des} - {\hat{V}}_{des} ) < {α}_{x , min} \\ p ( {V}_{des} - {\hat{V}}_{des} ) & if {α}_{x , min} \leq p ( {V}_{des} - {\hat{V}}_{des} ) \leq {α}_{x , max} \\ {α}_{x , max} & if p ( {V}_{des} - {\hat{V}}_{des} ) > {α}_{x , max}\end{matrix} ,$$

$${V}_{r} = {\hat{V}}_{des} - {V}_{f} ,$$

$$δ = {X}_{r} - {hV}_{f} - {S}_{0} ,$$

$${K}_{c} = ( \begin{matrix}{k}_{c , 1} & {k}_{c , 2}\end{matrix} ) , ; {K}_{f} = ( \begin{matrix}{k}_{f , 1} & {k}_{f , 2} & {k}_{f , 3}\end{matrix} ) ,$$

$${e}_{c} = ( \begin{matrix}{V}_{r} \\ {\int }_{0}^{t} {V}_{r} dt\end{matrix} ) , {e}_{f} = ( \begin{matrix}{V}_{r} \\ δ \\ {\int }_{0}^{t} ( {k}_{α} {V}_{r} + {k}_{b} δ ) dt\end{matrix} ) ,$$

$$sat ( {e}_{f} ) = ( \begin{matrix}{V}_{r} \\ sat ( δ ) \\ {\int }_{0}^{t} ( {k}_{α} {V}_{r} + {k}_{b} sat ( δ ) ) dt\end{matrix} ) ,$$

$$\overline{θ} = \{ \begin{matrix}{K}_{c} {e}_{c} & \begin{matrix}Cruising Mode \\ {P}_{c} \cdot {\overline{P}}_{f} = 1\end{matrix} \\ {K}_{f} sat ( {e}_{f} ) & \begin{matrix}Vehicle Following Mode : \\ {\overline{P}}_{c} \cdot {P}_{f} = 1\end{matrix}\end{matrix} .$$

The controller provided in (43), (38) can be stable by construction for δ without saturation. The controller ensures performance for appropriate choice of controller gains K_{f} and K_{c}. However, large separation error δ can be generated during lane change or during switching from cruising mode to the vehicle following mode. This large δ can result in high values of jerk which can cause discomfort. This issue can be addressed by using sat(δ). However, introducing sat(δ) instead of δ in feedback could cause stability issues. Thus, the controller (43, 38) can provide at least a technical improvement that ensures both performance and comfort under all cruising and vehicle following scenarios and road geometries. Performance can be defined as collision avoidance from any potential obstacle in the path lane of the ego vehicle. Comfort can be defined as limiting the lateral acceleration less than or equal to 0.2 g m/s².

For example, the throttle controller and the brake controller described by the equations (43), (38) ensure performance and comfort under all vehicle following and cruising conditions and road geometries. In the vehicle following mode, when the δ≤δₘₐₓ then the throttle controller (43) can be stable by construction. Consequently δ→>0 and Vᵣ→0.

When δ>δₘₐₓ then there can be two possibilities. If the δ moves in the direction that puts it under the saturation, then the spacing error and the speed error will converge to zero. If the spacing error keeps on increasing then eventually the relative distance Xᵣ=X_{r, max} where X_{r, max} can be the maximum relative spacing required for switching. When Xᵣ=X_{r,max} then the controller switches from the vehicle following mode to the cruising mode. In the cruising mode the controller tracks only V_{des}.

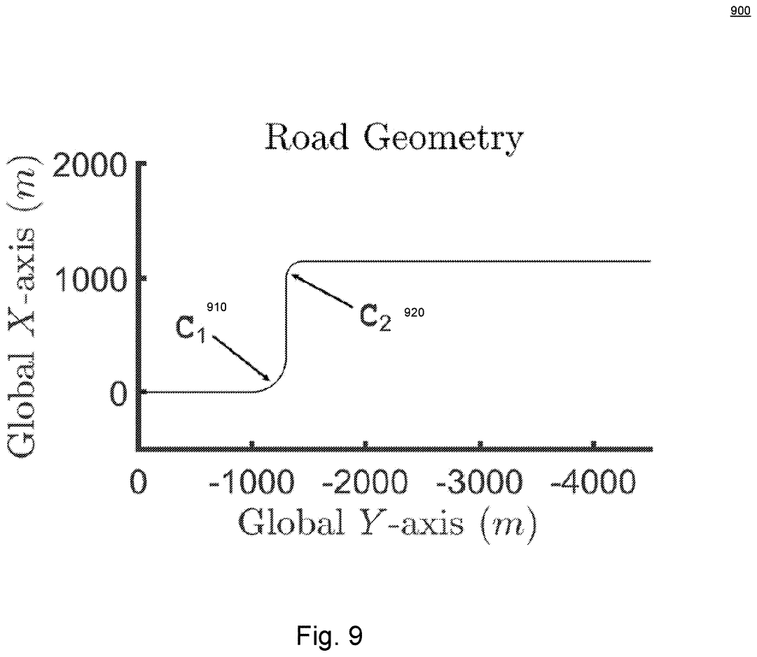

FIG. 9 illustrates a model corresponding to road geometry in accordance with present implementations. As illustrated by way of example in FIG. 9, an example model 900 can include a first curve 910 and a second curve 920. For example, FIG. 9 can be directed to Curve C₁: radius R₁=250 m, slope α₁=20°, lane width L₁=12 ft, superelevation e1=0; and Curve C₂: radius R₂=140 m, slope α₂=0°, lane width L₂=11 ft, superelevation e₂=0.08, coefficient of side friction fₛ=0.12.

The simulations can be run on a road scenario with three straight road segments and two curved road segments C₁ and C₂ as shown in FIG. 9. The C₁ has radius R₁=250 m, slope α₁=20°, superlevation e₁=0. The second curved road segment has radius R₂=140 m, slope α₂=0°, superelevation e₂=0.08 and side friction coefficient of fₛ=0.12. The sensor range X_{r,max}=300 m, θ_{az}=15° and field of view can be 30°. Yields performed simulations with and without sensor noise. In the presence of noise, σᵣ=2, σ_{θ}=1°, σ_{φ}=1°, σₓ=2, and σ_{y}=2. Yields modeled in-path potential obstacle as both high speed lead vehicle as well as very slow moving vehicle on the sharp curve in the ego vehicle's path lane. The following vehicle parameters can be used for simulation: Mass=M=1701 Kg, I_{z}=2873 Kg·m², I_{z}=2873 Kg·m², C_{af}=Cₐᵣ=80,000 N/rad, l_{f}=lᵣ=1.5 m, h=1, S₀=4.5, a=1, b=2, f₀=251.503, a₁=1, a₂=1.2, a₃=0.3, a₄=1.

In throttle controller design for vehicle following mode, one pole can be placed at λ=−10. The damping ratio can be ζ=0.9 and the natural frequency can be ωₙ=0.2. The other two poles can be placed at λ=−0.18±0.0872i. The controller gains can be calculated through standard pole-placement method. The throttle controller for the cruising mode can be designed by selecting two real negative poles λ=−2,−4. The throttle controller gains in the vehicle following mode and the cruising mode can be K_{f}=(3.2 1.4 0.2), kₐ=k_{b}=1. K_{c}=(2.5 4). Other parameters can be δₘₐₓ=5, β₁=1, β₂=1, X_{r,max}=300 m, a_{comf}=−2 m/s², a_{x,min}=−4 m/s², a_{x,max}=2 m/s², Xₘᵢₙ=6 m, Xₘₐₓ=40 m.

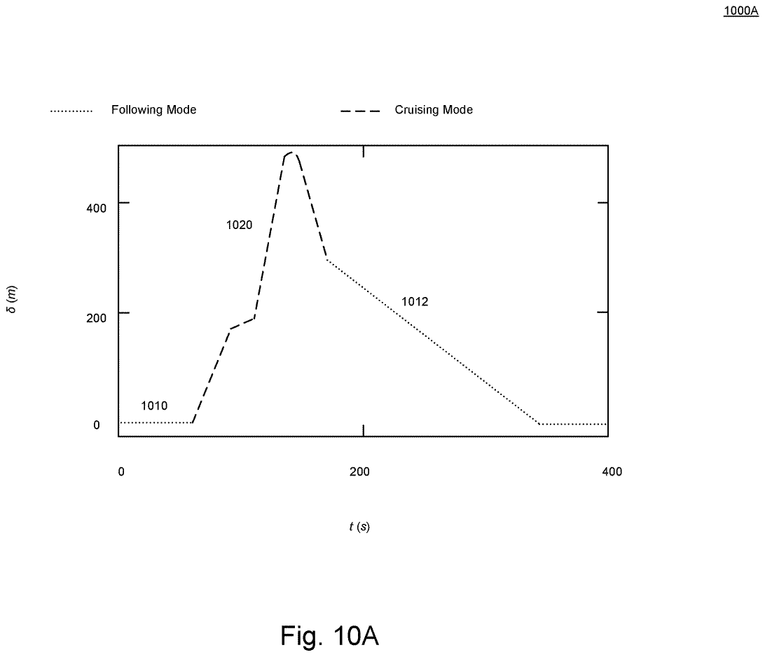

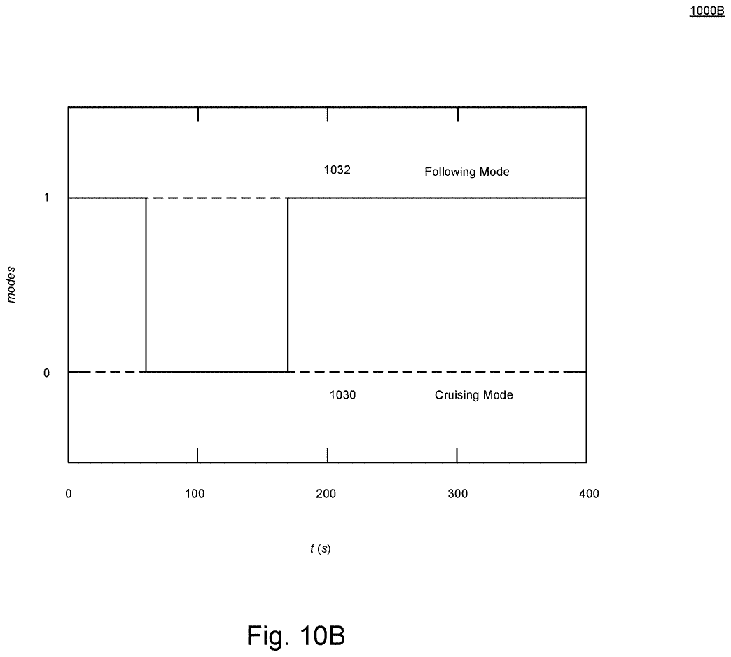

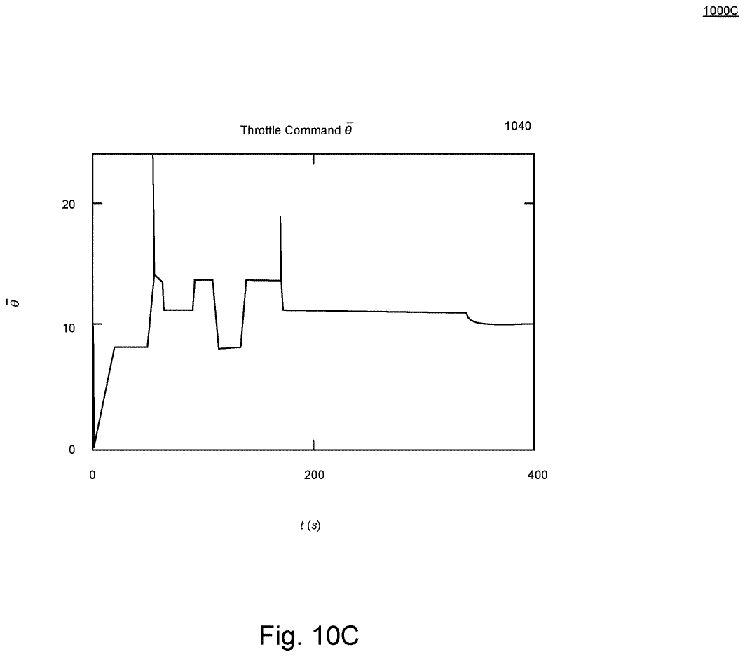

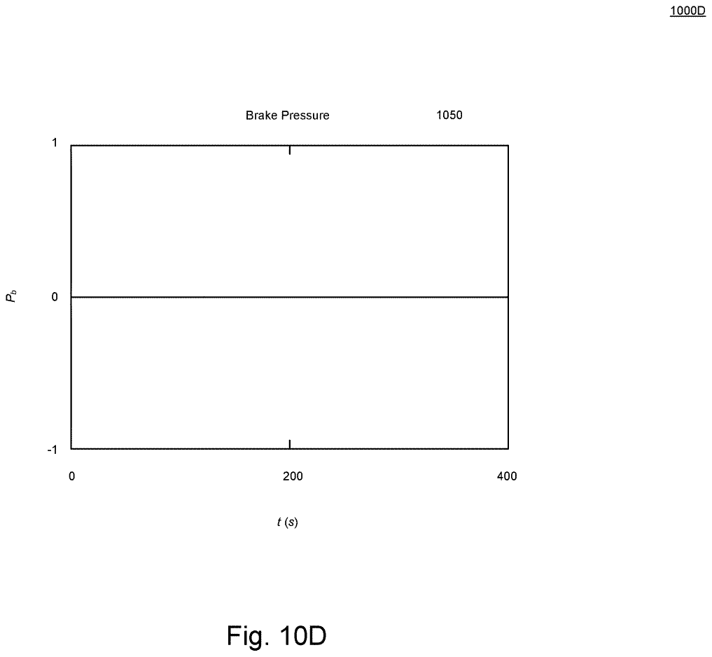

FIG. 10A illustrates a first model corresponding to various vehicle modes, in accordance with present implementations. As illustrated by way of example in FIG. 10A, an example model 1000A can model a cruising mode 1010 and 1012, and a following mode 1020. FIG. 10B illustrates a second model corresponding to various vehicle modes, in accordance with present implementations. As illustrated by way of example in FIG. 10B, an example model 1000B can model a cruising mode 1030 and a following mode 1032. FIG. 10C illustrates a model corresponding to throttle activation, in accordance with present implementations. As illustrated by way of example in FIG. 10C, an example model 1000C can model a throttle command 1040. FIG. 10D illustrates a model corresponding to brake activation, in accordance with present implementations. As illustrated by way of example in FIG. 10D, an example model 1000D can model a brake pressure 1050.

The deviation from desired inter-vehicle spacing can be shown in FIG. 10Aa, as spacing error δ in meters. During the time interval t₀≤t<t₅, the cruising mode can be selected, and the controller only tracks V_{des}. At t=t₅, the system switches from the cruising mode to the vehicle following mode and the controller starts following the lead vehicle while keeping constant headway policy. Therefore, during vehicle following mode the spacing error, eventually, converges to zero. Switching between different modes can be shown in FIG. 10B. The control commands from throttle controller and braking controller can be shown in FIG. 10C and FIG. 10D respectively.

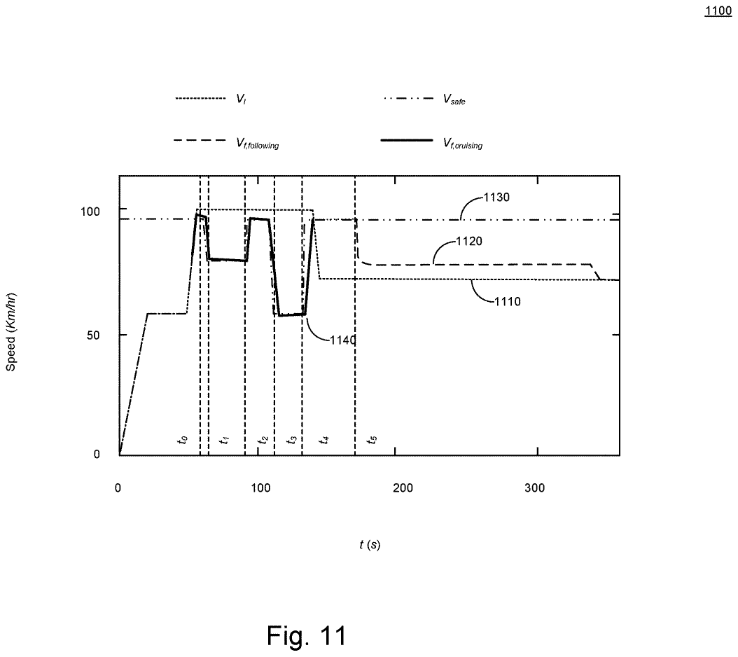

FIG. 11 illustrates a first operating profile of a vehicle, in accordance with present implementations. As illustrated by way of example in FIG. 11, an example operating profile 1100 can include a lead vehicle speed profile 1110, a following mode speed profile 1120 of a following vehicle, an optimal speed 1130 and a cruising mode speed profile 1140 of a following vehicle. For example, FIG. 11 can be directed to a seed profile of the lead vehicle Vₗ, the ego vehicle V_{f} and optimal speed V_{effective} without sensor noise, e.g., σᵣ=0, σ_{θ}=0°, σ_{φ}=0°, σₓ=0, and σ_{y}=0, road friction μ=0.5. The V_{f,following} and V_{f,cruising} show the ego vehicle's speed during the following mode (t<t₀ and t>t₅) and the cruising mode (t₀≤t≤t₅) respectively. The ego vehicle can be travelling on curved roads of radii R₁=250 and R₂=140 m for t₁≤t≤t₂ and t₃≤t≤t₄ respectively.

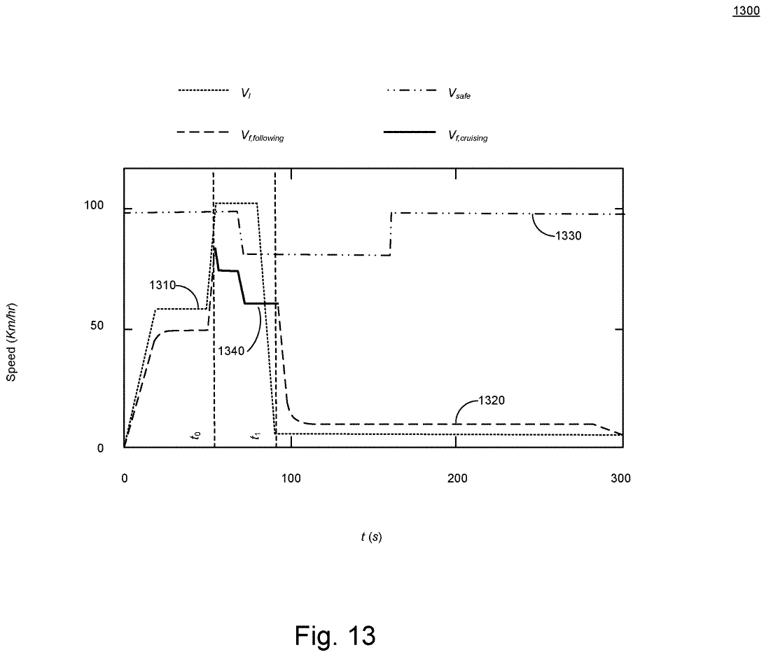

FIG. 11 shows the speed profile of the lead vehicle, the ego vehicle and the optimal speed limit in the absence of sensor noise. FIG. 13 shows the speed profile in the presence of sensor noise. First, consider FIG. 11. FIG. 11 shows the ego vehicle's speed during the vehicle following mode and the cruising mode. In FIG. 11, t₁, t₂ and t₃, t₄ indicate the times at which the ego vehicle enters and leaves the curve C₁ and C₂ respectively. The ego vehicle tracks the lead vehicle in the vehicle following mode during the time 0≤t<t₀. At t=t₀ the ego vehicle switches from the vehicle following mode to the cruising mode as the lead vehicle can be traveling at a Vₗ>V_{effective}. As the road curvature and distance of ego vehicle from the curve can be known, at t=t₀, the ego vehicle, preemptively, starts slowing down before entering the curve. From t=t₀ to t=t₁, the ego vehicle prepares to enter the curve and finally enters the curve at t=t₁ at an optimal and comfortable speed V_{effective}. During t₀≤t<t₅, the ego vehicle can be in the cruising mode. The ego vehicle leaves the curve C₁ at t=t₂. Since during the time interval t₂≤t<t₃, Xᵣ≥X_{r,max} holds, the ego vehicle continues in the cruising mode. In the meantime, the lead vehicle can be decelerating, so Xᵣ decreases. At t=t₃, the ego vehicle enters the second curved road segment C₂ and leaves it at t=t₄. At t>t₅, Xᵣ<X_{r,max} ∧Vₗ<V_{effective} holds, e.g., P_{f} can be satisfied. Hence the controller switches from the cruising mode to the vehicle following mode and starts tracking Vₗ while observing constant time headway policy. In essence, when P_{f}: [Vₗ<V_{effective} ∨δ<0]Xᵣ<X_{r,max} can be satisfied, the vehicle following mode can be selected. As soon as P_{c}: [Vₗ≥V_{effective} ∧δ≥0]∨Xᵣ≥X_{r,max} can be satisfied, the system switches from the vehicle following mode to the cruising mode. The speed of the ego vehicle can be less than or equal to V_{effective} to avoid collision with any potential obstacle. During the vehicle following mode, a constant headway policy can be observed. During the cruising mode, the speed can be kept at an optimal speed limit V_{effective}.

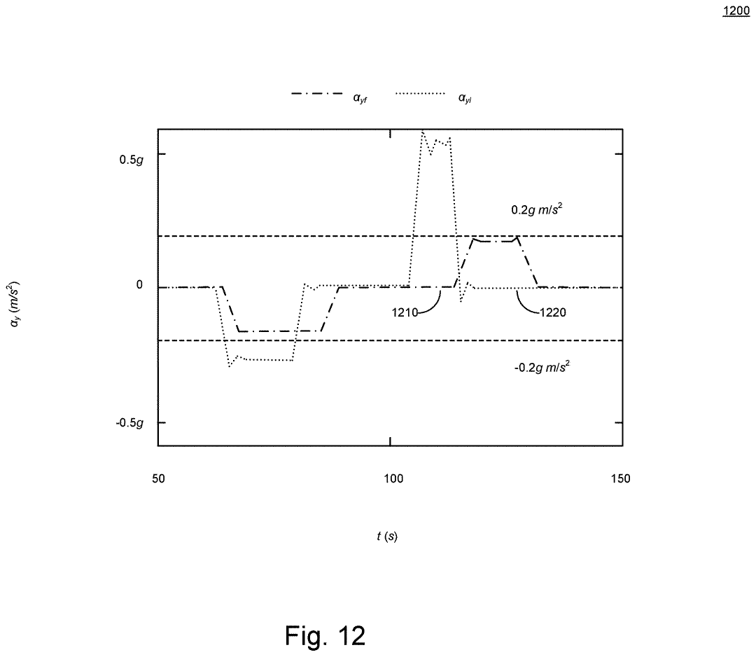

FIG. 12 illustrates a second operating profile of a vehicle, in accordance with present implementations. As illustrated by way of example in FIG. 12, an example operating profile 1200 can include acceleration of a following vehicle 1210 and acceleration of a lead vehicle 1220. For example, FIG. 12 can be directed to lateral acceleration of the lead vehicle a_{yl} and lateral acceleration of the ego vehicle a_{yf}. The ego vehicle maintains a comfortable lateral acceleration, e.g., |a_{yf}|≤0.2 g m/s². In FIG. 12, the lateral accelerations of the ego vehicle and the lead vehicle can be denoted by a_{yf} and a_{yl} respectively. FIG. 12 shows that the lateral acceleration of the lead vehicle can be very high, but the proposed controller maintains the lateral acceleration of the ego vehicle at a comfortable limit, e.g., |a_{yf}|≤0.2 g ms⁻².

FIG. 13 illustrates a third operating profile of a vehicle, in accordance with present implementations. As illustrated by way of example in FIG. 13, an example operating profile 1300 can include a lead vehicle speed profile 1310, a following mode speed profile 1320 of a following vehicle, an optimal speed 1330 and a cruising mode speed profile 1340 of a following vehicle. For example, FIG. 13 can be directed to a speed profile of the lead vehicle Vₗ, the ego vehicle V_{f} and optimal speed V_{effective} with respect to time under sensor noise (σᵣ=2, σ_{θ}=1°, σ_{φ}=1°, σₓ=2, σ_{y}=2) and slippery road, e.g., μ=0.3. The V_{f,following} and V_{f,cruising} show the ego vehicle's speed during the following mode (t<t₀ and t>t₁) and the cruising mode (t₀≤t≤t₁) respectively. In adverse conditions, the controller chooses a more conservative approach. Fort>t≥t₁, the obstacle can be a slow moving vehicle on the curve C₁. Now, consider the scenario in FIG. 13 which shows V_{f}, Vₗ and V_{effective} in the presence of sensor noise and slippery road conditions. By using the probabilistic criteria given in (43), the ego vehicle adopts a more conservative approach due to adverse conditions. This adaptive behavior enables the proposed system to provide performance for a wider range of driving conditions by reducing the instances which require human intervention.

FIG. 14 illustrates a processor architecture in accordance with present implementations. As illustrated by way of example in FIG. 14, an example processing system 1400 may include a system processor 1410, a parallel processor 1420, a transform processor 1430, a system memory 1440, and a communication interface 1450. In some implementations, at least one of the example processing system 1400 and the system processor 1410 may include a processor bus 1412 and a system bus 1414.

The system processor 1410 may be operable to execute one or more instructions. The instructions may be associated with at least one of the system memory 1440 and the communication interface 1450. The system processor 1410 may be an electronic processor, an integrated circuit, or the like including one or more of digital logic, analog logic, digital sensors, analog sensors, communication buses, volatile memory, nonvolatile memory, and the like. The system processor 1410 may include, but is not limited to, at least one microcontroller unit (MCU), microprocessor unit (MPU), central processing unit (CPU), graphics processing unit (GPU), physics processing unit (PPU), embedded controller (EC), or the like. The system processor 1410 may include a memory operable to store or storing one or more instructions for operating components of the system processor 1410 and operating components operably coupled to the system processor 1410. The one or more instructions may include at least one of firmware, software, hardware, operating systems, embedded operating systems, and the like.

The processor bus 1412 can be operable to communicate one or more instructions, signals, conditions, states, or the like between one or more of the system processor 1410, the parallel processor 1420, and the transform processor 1430. The processor bus 1412 may include one or more digital, analog, or like communication channels, lines, traces, or the like. It can be understood that any electrical, electronic, or like devices, or components associated with the system bus 1414 can also be associated with, integrated with, integrable with, supplemented by, complemented by, or the like, the system processor 1410 or any component thereof.

The system bus 1414 may be operable to communicate one or more instructions, signals, conditions, states, or the like between one or more of the system processor 1410, the system memory 1440, and the communication interface 1450. The system bus 1414 may include one or more digital, analog, or like communication channels, lines, traces, or the like. It can be understood that any electrical, electronic, or like devices, or components associated with the system bus 1414 can also be associated with, integrated with, integrable with, supplemented by, complemented by, or the like, the system processor 1410 or any component thereof.

The parallel processor 1420 may be operable to execute one or more instructions concurrently, simultaneously, or the like. The parallel processor 1420 may be operable to execute one or more instructions in a parallelized order in accordance with one or more parallelized instruction parameters. In some implementations, parallelized instruction parameters include one or more sets, groups, ranges, types, or the like, associated with various instructions. The parallel processor 1420 may include one or more execution cores variously associated with various instructions. The parallel processor 1420 may include one or more execution cores variously associated with various instruction types or the like. The parallel processor 1420 may be an electronic processor, an integrated circuit, or the like including one or more of digital logic, analog logic, communication buses, volatile memory, nonvolatile memory, and the like. The parallel processor 1420 may include but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It can be understood that any electrical, electronic, or like devices, or components associated with the parallel processor 1420 can also be associated with, integrated with, integrable with, supplemented by, complemented by, or the like, the system processor 1410 or any component thereof.

In some implementations, various cores of the parallel processor 1420 can be associated with one or more parallelizable operations in accordance with one or more metrics, engines, models, and the like, of the example computing system of FIG. 1. As one example, parallelizable operations include processing portions of an image, video, waveform, audio waveform, processor thread, one or more layers of a learning model, one or more metrics of a learning model, one or more models of a learning system, and the like. In some implementations, a predetermined number or predetermined set of one or more particular cores of the parallel processor 1420 can be associated exclusively with one or more distinct sets of corresponding metrics, engines, models, and the like, of the example computing system of FIG. 1. As one example, a first core of the parallel processor 1420 can be assigned to, associated with, configured to, fabricated to, or the like, execute one engine of the example computing system of FIG. 1. In this example, a second core of the parallel processor 1420 can also be assigned to, associated with, configured to, fabricated to, or the like, execute another engine of the example computing system of FIG. 1. Thus, the parallel processor 1420 may be configured to parallelize execution across one or more metrics, engines, models, and the like, of the example computing system of FIG. 1. Similarly, in some implementations, a predetermined number or predetermined set of one or more particular cores of the parallel processor 1420 can be associated collectively with corresponding metrics, engines, models, and the like, of the example computing system of FIG. 1. As one example, a first plurality of cores of the parallel processor can be assigned to, associated with, configured to, fabricated to, or the like, execute one engine of the example computing system of FIG. 1. In this example, a second plurality of cores of the parallel processor can also be assigned to, associated with, configured to, fabricated to, or the like, execute another engine of the example computing system of FIG. 1. Thus, the parallel processor 1420 may be configured to parallelize execution within one or more metrics, engines, models, and the like, of the example computing system of FIG. 1.

The transform processor 1430 may be operable to execute one or more instructions associated with one or more predetermined transformation processes. As one example, transformation processes include Fourier transforms, matrix operations, calculus operations, combinatoric operations, trigonometric operations, geometric operations, encoding operations, decoding operations, compression operations, decompression operations, image processing operations, audio processing operations, and the like. The transform processor 1430 may be operable to execute one or more transformation processes in accordance with one or more transformation instruction parameters. In some implementations, transformation instruction parameters include one or more instructions associating the transform processor 1430 with one or more predetermined transformation processes. The transform processor 1430 may include one or more transformation processes. Alternatively, in some implementations, the transform processor 1430 may be a plurality of transform processor 1430 associated with various predetermined transformation processes. Alternatively, the transform processor 1430 may include a plurality of transformation processing cores each associated with, configured to execute, fabricated to execute, or the like, a predetermined transformation process. The parallel processor 1420 may be an electronic processor, an integrated circuit, or the like including one or more of digital logic, analog logic, communication buses, volatile memory, nonvolatile memory, and the like. The parallel processor 1420 may include, but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It can be to be understood that any electrical, electronic, or like devices, or components associated with the transform processor 1430 can also be associated with, integrated with, integrable with, supplemented by, complemented by, or the like, the system processor 1410 or any component thereof.

The transform processor 1430 may be associated with one or more predetermined transform processes in accordance with one or more metrics, engines, models, and the like, of the example computing system of FIG. 1. In some implementations, a predetermined transform process of the transform processor 1430 can be associated with one or more corresponding metrics, engines, models, and the like, of the example computing system of FIG. 1. As one example, the transform processor 1430 can be assigned to, associated with, configured to, fabricated to, or the like, execute one matrix operation associated with one or more engines, metrics, models, or the like, of the example computing system of FIG. 1. As another example, the transform processor 1430 can alternatively be assigned to, associated with, configured to, fabricated to, or the like, execute another matrix operation associated with one or more engines, metrics, models, or the like, of the example computing system of FIG. 1. Thus, the transform processor 1430 may be configured to centralize, optimize, coordinate, or the like, execution of a transform process across one or more metrics, engines, models, and the like, of the example computing system of FIG. 1. The transform processor may be fabricated to, configured to, or the like, execute a particular transform process with at least one of a minimum physical logic footprint, logic complexity, heat expenditure, heat generation, power consumption, and the like, with respect to at least one metrics, engines, models, and the like, of the example computing system of FIG. 1.

For example, the system can include one or more processors corresponding to one or more of the processors 1410, 1420 and 1430. For example, one or more of the processors can detect, by the sensor of the vehicle, a state of the environment of the vehicle. For example, one or more of the processors can select, based on the detecting the state of the environment, a navigation input. For example, one or more of the processors can scan, based on the navigation input, the environment. For example, one or more of the processors can detect, by the sensor of the vehicle, that the environment can include a curved path. For example, one or more of the processors can modify, in response to identifying that the object corresponds to the lead vehicle, the mode of operation to a following mode. For example, one or more of the processors can modify, in response to identifying that the object corresponds to the potentially invisible vehicle in the path of the vehicle, the mode of operation to a predetermined speed. For example, one or more of the processors can modify, in response to identifying that the object corresponds to the stationary object, the mode of operation to stop the vehicle.

The system memory 1440 may be operable to store data associated with the example processing system 1400. The system memory 1440 may include one or more hardware memory devices for storing binary data, digital data, or the like. The system memory 1440 may include one or more electrical components, electronic components, programmable electronic components, reprogrammable electronic components, integrated circuits, semiconductor devices, flip flops, arithmetic units, or the like. The system memory 1440 may include at least one of a non-volatile memory device, a solid-state memory device, a flash memory device, and a NAND memory device. The system memory 1440 may include one or more addressable memory regions disposed on one or more physical memory arrays. In some implementations, a physical memory array may include a NAND gate array disposed on a particular semiconductor device, integrated circuit device, printed circuit board device, and the like.

The system memory 1440 can correspond to a computer readable medium. For example, the computer readable medium can include one or more instructions executable by one or more of the processors 1410, 1420 and 1430. The processor can determine, in response to the determination that the object corresponds to an in-path object, that the in-path object corresponds to a nearest in-path object to the vehicle. For example, the computer readable medium can include one or more instructions executable by the processor to detect, by the sensor of the vehicle, a state of the environment of the vehicle. For example, the computer readable medium can include one or more instructions executable by the processor to select, based on the detecting the state of the environment, a navigation input. For example, the computer readable medium can include one or more instructions executable by the processor to scan, based on the navigation input, the environment. For example, the computer readable medium can include one or more instructions executable by the processor to detect, via the sensor of the vehicle, that the environment can include a curved path. For example, the computer readable medium can include one or more instructions executable by the processor to modify, in response to identifying that the object corresponds to the lead vehicle, the mode of operation to a following mode. For example, the computer readable medium can include one or more instructions executable by the processor to modify, in response to identifying that the object corresponds to the potentially invisible vehicle in the path of the vehicle, the mode of operation to a predetermined speed. For example, the computer readable medium can include one or more instructions executable by the processor to modify, in response to identifying that the object corresponds to the stationary object, the mode of operation to stop the vehicle.

The communication interface 1450 may be operable to communicatively couple the system processor 1410 to an external device. In some implementations, an external device may include but is not limited to a smartphone, mobile device, wearable mobile device, tablet computer, desktop computer, laptop computer, cloud server, local server, and the like. The communication interface 1450 may be operable to communicate one or more instructions, signals, conditions, states, or the like between one or more of the system processor 1410 and the external device. The communication interface 1450 may include one or more digital, analog, or like communication channels, lines, traces, or the like. As one example, the communication interface 1450 can be or may include at least one serial or parallel communication line among multiple communication lines of a communication interface. The communication interface 1450 may be or may include one or more wireless communication devices, systems, protocols, interfaces, or the like. The communication interface 1450 may include one or more logical or electronic devices including but not limited to integrated circuits, logic gates, flip-flops, gate arrays, programmable gate arrays, and the like. The communication interface 1450 may include ones or more telecommunication devices including, but not limited to, antennas, transceivers, packetizers, wired interface ports, and the like. It can be understood that any electrical, electronic, or like devices, or components associated with the communication interface 1450 can also be associated with, integrated with, integrable with, replaced by, supplemented by, complemented by, or the like, the system processor 1410 or any component thereof.

Due to the curvature of the road, the effective range of the sensors can be decreased. None of the existing sensors based on forward-looking beams can tell what can be around the curve in the area that can be outside the view of vehicle no matter how accurate they are. On sharp curves, the sensors could fail to detect objects like car parked on the edge of the road. Therefore, any autonomous car and vehicle following system must be equipped with the capability to avoid potential in-path objects not visible with on-board exteroceptive sensors. Thus, this technical solution can be directed at least to a control design for automatic vehicle following and cruising system which guarantees collision avoidance with in-path objects not visible with the on-board sensors while keeping the lateral acceleration less than ISO-15622 recommended limit of 0.2 g m/s⁻². The proposed system calculates the optimal and comfortable velocity by taking into account of the range and the field of view of the sensors, geometry of the road (curvature, slope, and superlevation), weather conditions and maximum braking deceleration available. In faulty sensor measurements or on sharp curves where objects on the edge of the lane can be invisible by on-board sensors, the proposed system preemptively slows vehicle down to an optimal speed which ensures that collision with any potential in-path obstacle can be avoided. The proposed control methodology ensures that under all road geometric characteristics and adverse weather conditions, the ego vehicle can effectively and comfortably cruise and follow a lead vehicle. The current automatic car following systems rely on LiDAR, camera, and radar for object detection and tracking. In adverse weather around curved paths, LiDAR and camera pose serious performance concerns. The proposed methodology utilizes geo-referenced maps along with radar for effective in-path object detection and tracking. It takes into account localization error as well as errors in measurement of range and angle of the detected object. A probabilistic method of determining the desired velocity V_{des} can be proposed. The desired velocity V_{des} can be a function of the optimal speed limit V_{effective}, the velocity of the detected object Vₗ and the probability Pᵢₙ₋ₚₐₜₕ that the detected object can be in ego vehicle's path. If Pᵢₙ₋ₚₐₜₕ can be high then the desired velocity of the ego vehicle V_{f} can be set closer to Vₗ. The proposed system ensures both comfort and performance of the passengers. Simulations results show that proposed system fulfills all the performance and comfort constraints.

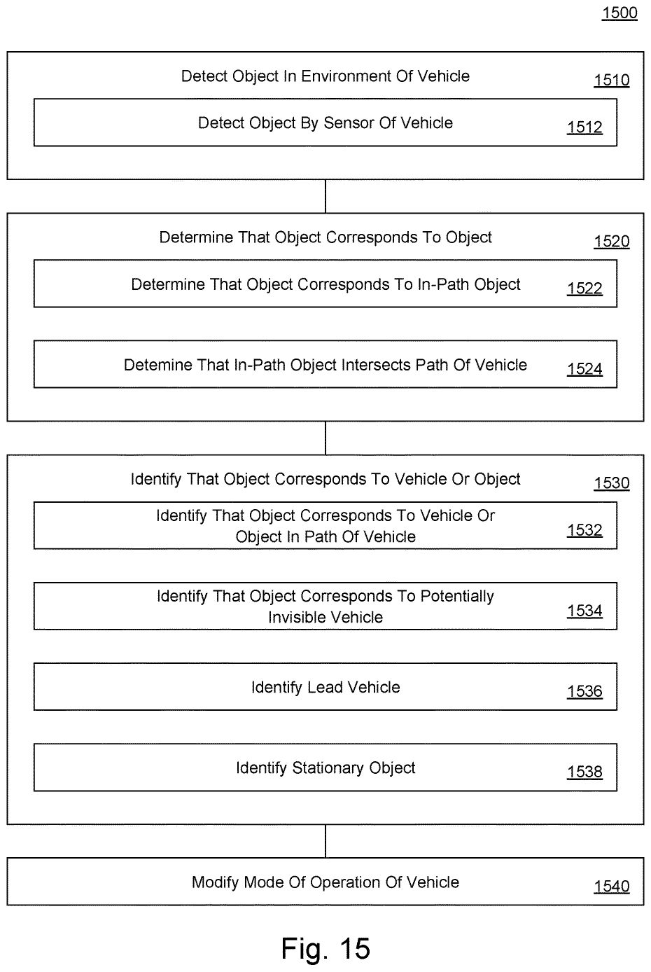

FIG. 15 depicts an example method of coordination of vehicle operation, in accordance with present implementations. At least the system 100 or the processor architecture 1400, or any one or more components thereof, can perform method 1500.

At 1510, the method 1500 can detect an object in an environment of the vehicle. For example, the method can include detecting, by the sensor of the vehicle, a state of the environment of the vehicle. The method can include selecting, based on the detecting the state of the environment, a navigation input, and scanning, based on the navigation input, the environment. For example, the vehicle can detect, by the sensor of the vehicle, a state of the environment of the vehicle. For example, the vehicle can select, based on the detecting the state of the environment, a navigation input. For example, the vehicle can scan, based on the navigation input, the environment. At 1512, the method 1500 can detect the object by a sensor of a vehicle. For example, the method can include detecting, by the sensor of the vehicle, that the environment can include a curved path. For example, the vehicle can detect, by the sensor of the vehicle, that the environment can include a curved path.

At 1520, the method 1500 can determine that the object corresponds to an object. At 1522, the method 1500 can determine that the object corresponds to an in-path object. For example, the method can include determining, in response to the determination that the object corresponds to an in-path object, that the in-path object corresponds to a nearest in-path object to the vehicle. For example, the system can determine, in response to the determination that the object corresponds to an in-path object, that the in-path object corresponds to a nearest in-path object to the vehicle. For example, the vehicle can determine, in response to the determination that the object corresponds to an in-path object, that the in-path object corresponds to a nearest in-path object to the vehicle. At 1524, the method 1500 can determine that the in-path object intersects a path of the vehicle.

At 1530, the method 1500 can identify that the object corresponds to a vehicle or object. At 1532, the method 1500 can identify that the object corresponds to a vehicle or object in the path of the vehicle. At 1534, the method 1500 can identify that the object corresponds to a potentially invisible vehicle. At 1536, the method 1500 can identify a lead vehicle. At 1538, the method 1500 can identify a stationary object.

At 1540, the method 1500 can modify a mode of operation of the vehicle. For example, the method can include modifying, in response to identifying that the object corresponds to the lead vehicle, the mode of operation to a following mode. For example, the vehicle can modify, in response to identifying that the object corresponds to the lead vehicle, the mode of operation to a following mode. For example, the method can include modifying, in response to identifying that the object corresponds to the potentially invisible vehicle in the path of the vehicle, the mode of operation to a predetermined speed. For example, the vehicle can modify, in response to identifying that the object corresponds to the potentially invisible vehicle in the path of the vehicle, the mode of operation to a predetermined speed. For example, the method can include modifying, in response to identifying that the object corresponds to the stationary object, the mode of operation to stop the vehicle. For example, the vehicle can modify, in response to identifying that the object corresponds to the stationary object, the mode of operation to stop the vehicle.

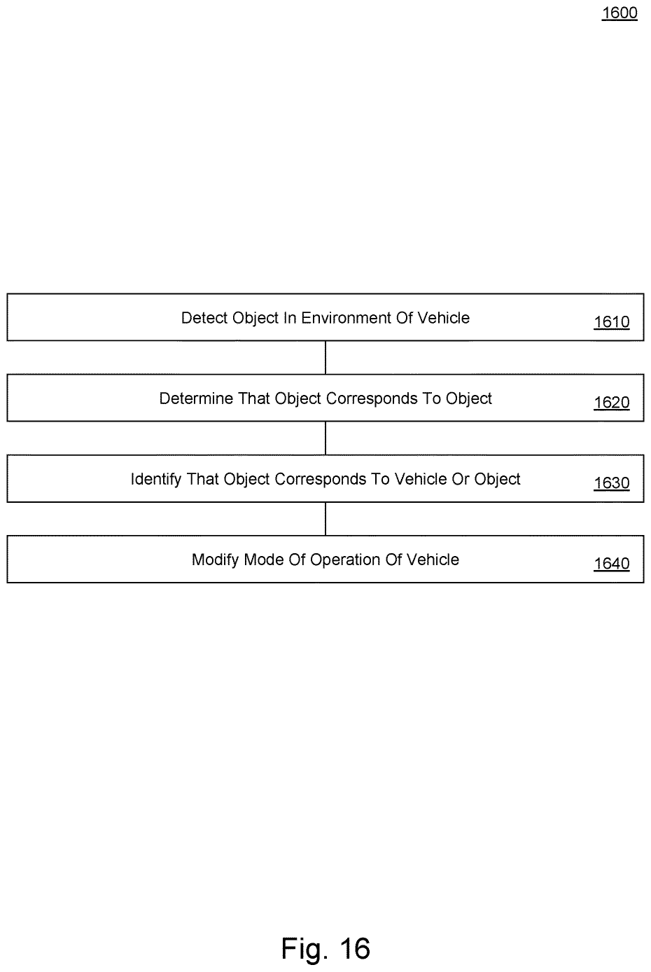

FIG. 16 depicts an example method of coordination of vehicle operation, in accordance with present implementations. At least the system 100 or the processor architecture 1400, or any one or more components thereof, can perform method 1600. At 1610, the method 1600 can detect an object in an environment of the vehicle. For example, 1610 can correspond at least partially in one or more of structure and operation to 1510. At 1620, the method 1600 can determine that the object corresponds to an object. For example, 1620 can correspond at least partially in one or more of structure and operation to 1520. At 1630, the method 1600 can identify that the object corresponds to a vehicle or object. For example, 1630 can correspond at least partially in one or more of structure and operation to 1530. At 1640, the method 1600 can modify a mode of operation of the vehicle. For example, 1640 can correspond at least partially in one or more of structure and operation to 1540.

Having now described some illustrative implementations, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Scope of the systems and methods described herein is thus indicated by the appended claims, rather than the foregoing description. The scope of the claims includes equivalents to the meaning and scope of the appended claims.

1. A method for coordination of vehicle operation, the method comprising:
detecting, by a sensor of a vehicle, an object in an environment of the vehicle;
determining, in response to the detecting, that the object corresponds to an in-path object intersecting a path of the vehicle;
identifying, in response to the detecting, that the object corresponds to a potentially invisible vehicle in the path of the vehicle, a lead vehicle, or a stationary object; and
modifying a mode of operation of the vehicle in response to the identifying.

2. The method of claim 1, further comprising:
determining, in response to the determination that the object corresponds to an in-path object, that the in-path object corresponds to a nearest in-path object to the vehicle.

3. The method of claim 1, further comprising:
detecting, by the sensor of the vehicle, a state of the environment of the vehicle;
selecting, based on the detecting the state of the environment, a navigation input; and
scanning, based on the navigation input, the environment.

4. The method of claim 1, further comprising:
detecting, by the sensor of the vehicle, that the environment includes a curved path.

5. The method of claim 1, further comprising:
modifying, in response to identifying that the object corresponds to the lead vehicle, the mode of operation to a following mode.

6. The method of claim 1, further comprising:
modifying, in response to identifying that the object corresponds to the potentially invisible vehicle in the path of the vehicle, the mode of operation to a predetermined speed.

7. The method of claim 1, further comprising:
modifying, in response to identifying that the object corresponds to the stationary object, the mode of operation to stop the vehicle.

8. A system for coordination of vehicle operation, the system comprising:
a memory and one or more processors to:
detect, by a sensor of a vehicle, an object in an environment of the vehicle;
determine, in response to the detection, that the object corresponds to an in-path object intersecting a path of the vehicle;
identify, in response to the detection, that the object corresponds to a potentially invisible vehicle in the path of the vehicle, a lead vehicle, or a stationary object; and
modify a mode of operation of the vehicle in response to the identifying.

9. The system of claim 8, the processors to:
determine, in response to the determination that the object corresponds to an in-path object, that the in-path object corresponds to a nearest in-path object to the vehicle.

10. The system of claim 8, the processors to:
detect, by the sensor of the vehicle, a state of the environment of the vehicle;
select, based on the detecting the state of the environment, a navigation input; and
scan, based on the navigation input, the environment.

11. The system of claim 8, the processors to:
detect, by the sensor of the vehicle, that the environment includes a curved path.

12. The system of claim 8, the processors to:
modify, in response to identifying that the object corresponds to the lead vehicle, the mode of operation to a following mode.

13. The system of claim 8, the processors to:
modify, in response to identifying that the object corresponds to the potentially invisible vehicle in the path of the vehicle, the mode of operation to a predetermined speed.

14. The system of claim 8, the processor to:
modify, in response to identifying that the object corresponds to the stationary object, the mode of operation to stop the vehicle.

15-21. (canceled)

22. A non-transitory computer readable medium including one or more instructions stored thereon and executable by a processor to:
detect, by the processor via a sensor of a vehicle, an object in an environment of the vehicle;
determine, by the processor in response to the detection, that the object corresponds to an in-path object intersecting a path of the vehicle;
identify, by the processor in response to the detection, that the object corresponds to a potentially invisible vehicle in the path of the vehicle, a lead vehicle, or a stationary object; and
modify, by the processor, a mode of operation of the vehicle in response to the identifying.

23. The computer readable medium of claim 22, the computer readable medium further includes one or more instructions executable by the processor to:
determine, by the processor in response to the determination that the object corresponds to an in-path object, that the in-path object corresponds to a nearest in-path object to the vehicle.

24. The computer readable medium of claim 22, the computer readable medium further includes one or more instructions executable by the processor to:
detect, by the sensor of the vehicle, a state of the environment of the vehicle;
select, based on the detecting the state of the environment, a navigation input; and
scan, based on the navigation input, the environment.

25. (canceled)

26. The computer readable medium of claim 22, the computer readable medium further includes one or more instructions executable by the processor to:
modify, by the processor in response to identifying that the object corresponds to the lead vehicle, the mode of operation to a following mode.

27. The computer readable medium of claim 22, the computer readable medium further includes one or more instructions executable by the processor to:
modify, by the processor in response to identifying that the object corresponds to the potentially invisible vehicle in the path of the vehicle, the mode of operation to a predetermined speed.

28. The computer readable medium of claim 22, the computer readable medium further includes one or more instructions executable by the processor to:
modify, by the processor in response to identifying that the object corresponds to the stationary object, the mode of operation to stop the vehicle.
